(19) United States
(12) Patent Application Publication
(10) Pub. No.: US 2005/0015780 A1
(43) Pub. Date: Jan. 20, 2005

(54) Method and system for providing information related to elements of a user interface

(75) Inventors: Brendan McKeon, Seattle, WA (US); Michael Edward Dulac Winser, Westport, CT (US); Patricia Mary Wagoner, Redmond, WA (US)

Correspondence Address: SHOOK, HARDY & BACON L.L.P., 2555 GRAND BOULEVARD, KANSAS CITY, MO, 64108-2613, US

(73) Assignee: Microsoft Corporation, Redmond, WA (US)

(21) Appl. No.: 10/916,715

(22) Filed: Aug. 12, 2004

Related U.S. Application Data
(63) Continuation-in-part of application No. 10/439,514, filed on May 16, 2003.
(63) Continuation-in-part of application No. 10/868,248, filed on Jun. 15, 2004.
Application No. 10/868,248 is a continuation-in-part of application No. 10/703,889, filed on Nov. 7, 2003.

(51) Int. Cl. G06F 3/00

(52) U.S. Cl. 719/328; 719/329

(57) ABSTRACT

A method, apparatus, and medium are provided for obtaining information related to elements of a user interface that reside in a process separate from that of a requesting component in some embodiments. The method includes providing a request to identify an element of interest, providing a list of attributes that are desired to be returned in connection with the element of interest, requesting the element of interest, and contemporaneously returning attribute information according to the list of attributes with the element of interest.

### CROSS-REFERENCE TO RELATED APPLICATIONS

This application is a Continuation-in-Part (CIP) of two pending applications: U.S. application Ser. No. 10/439,514, filed May 16, 2003, and U.S. application Ser. No. 10/868,248, filed Jun. 15, 2004 (which is a Continuation-in-Part of U.S. application Ser. No. 10/703,889, filed Nov. 7, 2003, and having atty. docket no. MFCP.110235). The content of each of these three applications, including drawings, is expressly incorporated by reference herein.

The title of application Ser. No. 10/439,514 is “USER INTERFACE AUTOMATION FRAMEWORK CLASSES AND INTERFACES,” and its corresponding attorney docket number is MFCP.105309.

The title of application Ser. No. 10/868,248 is “METHOD AND SYSTEM FOR PRESENTING USER INTERFACE (UI) INFORMATION,” and it's corresponding attorney docket number is MFCP.112687.

### STATEMENT REGARDING FEDERALLY SPONSORED RESEARCH OR DEVELOPMENT

Not applicable.

### TECHNICAL FIELD

This invention relates to the field of gathering information related to elements of a user interface in a computing environment.

### BACKGROUND OF THE INVENTION

Individuals interact with computers through a user interface. The user interface enables a user to provide input to and receive output from the computer. The output provided can take on many forms and often includes presenting a variety of user-interface elements, sometimes referred to as “controls.” Exemplary user-interface elements include toolbars, windows, buttons, scrollbars, icons, selectable options, graphics that compose controls (such as images, text, etc.) and the like. Virtually anything that can be clicked on or given the focus falls within the scope of “element” as used herein. Information related to user-interface elements is often requested by assistive-technology products so that the products can enhance a user's computing experience.

Assistive-technology products are specially designed computer programs designed to accommodate an individual's disability or disabilities. These products are developed to work with a computer's operating system and other software. Some people with disabilities desire assistive-technology products to use computers more effectively.

Individuals with visual or hearing impairments may desire accessibility features that can enhance a user interface. For example, individuals with hearing impairments may use voice-recognition products that are adapted to convert speech to sign language. Screen-review utilities make on-screen information available as synthesized speech and pairs the speech with visual representations of words in a format that assists persons with language impairments. For example, words can be highlighted as electronically read. Screen-review utilities convert text that appears on screen into a computer voice.

To provide supportive features to persons that desire to use them, assistive-technology applications do not have access to the same code that native applications are able to use. This is because an assistive-technology application works on behalf of a user; instead of the user working directly with the user interface—as is the case in native applications. For instance, if a word-processing application wishes to display text to user, it can easily do so because the word-processing application knows what program modules to call to display the text as desired. But a screen reader—an application that finds text and audibly recites the text to a user—is unaware of much of a target application's programmatic code. The screen reader must independently gather the data needed to identify text, receive it, and translate it into audio.

Assistive-technology applications work under a variety of constraints. To further illustrate a portion of the constraints that assistive-technology applications are subject to, consider, for example, an application that needs to display the contents of a listbox. This would be an easy task for a native application because it would know where the relevant list-box values are stored and simply retrieve them for display. But an assistive-technology application does not know where the values are stored. It must seek the values itself and be provided with the necessary information to display the values. Thus, assistive-technology applications must function with limited knowledge of an application's user interface.

The difficulties associated with an assistive-technology application performing certain functions on all types of user-interface elements is somewhat akin to the difficulties that would be faced by a person asked to be able to program any type of VCR clock simply by providing access to the VCR clock. Unlike the VCR owner who is familiar with his VCR's clock and has the VCR manual, the fictitious person here has no foreknowledge of what type of VCR he may come across, what type of actions are necessary to program the clock, whether it will be a brand ever seen before, or the means of accessing its settings—which may be different from every other VCR previously encountered. Moreover, expecting the person to know about every type of VCR is an unrealistic proposition. As applicable to the relevant art, it is an unrealistic proposition to expect every requesting component to know about every type of listbox that it might encounter. Programming such a requesting component would be an expensive and resource intensive process.

One way a user interface may provide this information is by using logical hierarchal structures. A significant problem in the art, however, is that logical hierarchal structures provided by a user interface often do not have the requisite level of granularity needed by an assistive-technology application. Without the benefit of an adequate description of a UI or knowing the contents of certain data elements (such as listboxes, combo boxes, and many others), assistive-technology applications must request this information from the user interface to be able to manipulate or otherwise make use of the data.

Although requesting components such as assistive-technology applications can provide various user-interface customizations if they can receive accurate data regarding the user-interface elements, providing accurate information regarding user-interface elements has proven difficult. This difficulty stems from the fact that no single entity knows all the relevant information about any particular piece of a user interface. For example, although a list-box component may itself know the individual list-box items contained within it, only the name of the listbox may be known by its parent dialog window. Although a user interface or portion of a user interface may be depicted as a hierarchal structure such as a tree, a single tree may only provide limited information, which can prevent an assistive-technology application from functioning properly.

A user interface is typically composed of elements from various different platforms in various different processes, complicating interaction with the UI. A platform is a suite of APIs, libraries, and/or components that comprise building blocks of an operating system. A first exemplary platform is the “WIN32” platform, which uses HWNDs as a basic element type. A second illustrative platform is HTML, which uses HTML elements to compose a platform. Other illustrative platforms include those used to develop a Linux or Macintosh® user interface. These platforms often have incompatible APIs. For example, HTML uses a first platform to build its user interface, but controls in a WIN32 environment use another platform to build their UI. These disparate UI platforms live as a collection of disjointed trees, a scheme which is difficult for client applications (or requesting applications) to interact with. The UI of an application can be illustrated as a set of UI elements that are arranged in a hierarchy that typically indicates containment (although HTML allows child elements to be positioned on the screen outside of the bounds of parent elements). For example, a desktop may contain multiple application windows, one of which may contain a title bar, scrollbars, controls, which may include a list control, which may in turn contain list items, which may still further contain text and images. We note that the term “desktop” is commonly associated with an aspect of the Windows® operating system produced by Microsoft Corporation of Redmond, Wash., but we do not mean to associate such a narrow definition to the term as used herein. Rather, “desktop” is a term that we will often refer to as representing the highest level of a hierarchal tree. Other operating systems, such as Linux; the Mac OS™ offered by Apple Computer, Inc. of Cupertino, Calif.; the Solaris™ Operating System offered by Sun Microsystems, Inc. of Santa Clara, Calif.; and other operating systems have work spaces that represent the top-most level of a user interface. It is that upper-most level of interest, which may not necessarily be the top level, that we intend to describe as the term “desktop” is used throughout this disclosure.

As previously mentioned, the system that manages a particular set of elements is referred to as a platform. Exemplary functions performed by platforms include allocating and subdividing screen real estate (for example, deciding where a list box should be placed and ensuring that its drawing does not interfere with other elements); routing input (such as mouse clicks and keyboard presses) to correct elements; and managing basic UI-related state for an element (such as focus, enabled, location, and the like).

Also, any control that manages screen real estate and/or input can be regarded as a platform. For example, a list box is limited in functionality, but it does manage the location of its list items, and it also manages input on their behalf. Accordingly, such an item falls within the meaning of “platform” as used herein.

Because the different platforms all use different interfaces to obtain information about their underlying elements, they are generally incompatible. That is, code written to retrieve information associated with a child of a node in a first application would be different than code that retrieves a similar topological node in a different platform. Developers often use different platforms for different reasons. Some platforms are better suited to carry out various functions than are other platforms. When multiple platforms are used within an application, it is often the case that the platforms are not explicitly aware of how they are connected. For example, a list box (a WIN32 element) within a table in a Web page (HTML elements) has no knowledge that it is within the table.

Still further compounding the problem associated with a requesting component interacting with various UI elements is the fact that platforms typically store information within the process that is displaying the UI. For example, in a calculator application, the element tree structure may be contained entirely within the calculator process. As will be explained in greater detail below, crossing process boundaries can negatively impact system performance. As previously mentioned, tools, applications, and other requesting components that wish to access a UI to obtain information about it or to interact with it has historically had to deal with at least the following exemplary problems: maintaining awareness of multiple incompatible platforms, crossing process boundaries to retrieve information about different user interfaces, and being aware of transitions from one platform to another to hopefully enable navigation between user interfaces that are composed of multiple disjoint subtrees. A developer faced with addressing such problems faced a formidable task to develop a requesting component that could richly interact with UI elements of various user interfaces.

Another significant shortcoming of the prior art is the lack of flexibility that a client application or other requesting component has with respect to viewing a tree that represents elements of a user interface. A tree that represents all elements of a user interface may be referred to as a raw tree. This raw tree, according to the present invention described below, can include levels of granularity never before possible. But a requesting client may not need such level of granularity. For instance, a client may only be interested in receiving information associated with UI elements that can receive user input. Or perhaps a requesting component desires to navigate to some next node that satisfies a condition, such as having a specific name. The prior art does not allow for the submission of any such condition to a platform. Absent the present invention, a requesting client application is at the mercy of receiving uncustomized views of representations of user-interface elements.

Often, a client application (such as a screen reader, magnifier, or control application for example) manifests itself as a process distinct from a UI, from which the client application would like to gather information. Thus, to gather information about the UI (or UIs) and the elements that make it up, the client application must iteratively make expensive cross-process calls. For example, the client application may make a first call to return the element; then a second call to determine the element's name; a third to determine whether it possesses a certain functional aspect; etc. Each one of these cross-process calls is resources intensive and can ultimately lead to poor client-application performance. This repetitive process is relatively slow and inefficient because (1) process boundaries must be crossed and data returned to the client on every node and (2) control returns to the client between nodes (thus, there is no opportunity to maintain state between nodes), among other things.

Accordingly, a shortcoming exists in the current state of the art whereby providing information about a UI or UI elements is slow and resource intensive. There is a need for a method and system for contemporaneously returning attribute information along with a requested element or set of elements so that cross-process calls are reduced, and processing performance enhanced.

### SUMMARY OF THE INVENTION

The present invention addresses at least the above problems by providing a system and method for prefetching attribute information at the time of retrieving UI-element information. The present invention has several practical applications in the technical arts not limited to providing more comprehensive user-interface information to requesting applications, simplifying the development of components that interact with a user interface (UI), simplifying navigation of structure representing UI elements, providing the ability to define or specify custom views of a raw tree, and increasing run-time performance.

Reusing state information between nodes offers performance benefits. Two important aspects related to bulk retrieval include: 1) a mechanism to actually make the necessary calls behind the scenes, replacing many cross-process calls with just one and 2) an API that enables this, or exposes this functionality. An embodiment of the present invention enables this functionality—instead of using methods that operate on one piece of information at a time, the present invention employs methods that allow for requests to be assembled and issued. According to an aspect of one embodiment, an API firstly enables the transition from many to fewer (ideally one) cross-process calls; but it also offers the additional benefit of allowing other optimizations by enabling internal state information to be reused between nodes.

Among other things, the present invention reduces a client application's burden associated with traversing a target tree. According to some embodiments, the present invention enables a client to traverse any specified portion of logical or raw trees, facilitates the returning of a collection of nodes that match a set of specified conditions, and to return a collection of properties about those nodes and to return structure information about the traversed tree.

Further, the present invention allows a client application to specify what attributes (properties, pattens, etc.) to prefetch when the client issues “find” functionality. The invention integrates these features into a notion of a logical element so that clients using the logical element will be using the prefetching and tree-walking functionality described below and in the aforementioned patent applications incorporated by reference herein.

In a first aspect, the present invention includes a computer-implemented method for obtaining information related to elements of a user interface. The method includes providing a request to identify an element of interest, providing a list of attributes that are desired to be returned in connection with the element of interest, requesting the element of interest, and contemporaneously returning attribute information according to the list of attributes with the element of interest. The present invention can also return attributes of related elements (e.g. children or other descendants), such as names and types of one or more nodes as well as attributes of their.

In a second aspect, a method for a client application residing in a first process space of obtaining information related to user-interface (UI) elements of a target component residing in a second process space is provided. The method includes describing one or more target UI elements (such as describing the scope of a UI element sub-tree) of the target component that is the subject of a query request, describing one or more attributes of interest that are associated with the one or more target UI elements (including in some embodiments those to be returned to the client application), initiating a single cross-process call from the client application to the target component, and without any further cross-process calls (other than those used to return desired information), returning to the client application results of the query request and the one or more described attributes.

In a third aspect, an API embodied on one or more computer-readable media for obtaining information related to elements of a user interface is provided. The API includes code for receiving a request from a first application for information related to one or more UI elements, wherein the request includes a description of attribute information related to the one or more UI elements; communicates the request to a receiving component that provides both relationship information and attribute information regarding the one or more UI elements; and contemporaneously communicates both the relationship information and the attribute information to the first application.

In a final illustrative aspect, one or more computer-readable media having computer-useable instructions embodied thereon for performing a method of providing information about one or more user-interface (UI) elements to a client application. The method includes requesting in a single call structural information and attribute information related to elements of a UI (UI elements), and satisfying the request by providing attribute information together with structural information incident to receiving the single call.

### BRIEF DESCRIPTION OF THE SEVERAL VIEWS OF THE DRAWINGS

The present invention is described in detail below with reference to the attached drawing figures, which are incorporated by reference herein, and wherein:

FIG. 1 depicts a first exemplary computing environment suitable for practicing an embodiment of the present invention;

FIG. 2 is block diagram depicting an exemplary data-flow model according to an embodiment of the present invention;

FIG. 3 depicts an illustrative node having links, properties, and patterns and illustrates a user-interface portion that requires two hierarchal structures to describe it;

FIG. 4 visually depicts a problem to be solved by the present invention, namely how to merge two hierarchal structures;

FIG. 5 is a block diagram depicting an object of the present invention, to represent two or more logical trees as a single tree;

FIG. 6 is a block diagram depicting the various node relationships available to a node in accordance with an embodiment of the present invention;

FIG. 7A is a more detailed diagram illustrating bidirectional data-flow requirements in accordance with an embodiment of the present invention;

FIG. 7B is a block diagram that illustrates a portion of the problems and disadvantages associated with directly grafting a first tree onto a second tree;

FIG. 7C is a block diagram illustrating a merging of two trees in accordance with an embodiment of the present invention;

FIG. 8 is a block diagram illustrating how consolidators are used to traverse a merged tree in accordance with an embodiment of the present invention;

FIG. 9 is a data-flow diagram illustrating that two or more hierarchal structures appear as a single hierarchal structure to a requesting component;

FIG. 10 is a second illustrative operating environment in accordance with an embodiment of the present invention;

FIGS. 11A-11G show various tree diagrams that illustrate depictions of raw and views of UI elements in accordance with an embodiment of the present invention;

FIG. 12 depicts an exemplary target component in accordance with an embodiment of the present invention;

FIG. 13A depicts an illustrative tree structure corresponding to the target component of FIG. 12 in accordance with an embodiment of the present invention;

FIGS. 13B-13C depict illustrative custom views of the raw tree of FIG. 13A in accordance with an embodiment of the present invention; and

FIG. 14 depicts an illustrative raw tree and a corresponding custom view of that tree per a condition in accordance with an embodiment of the present invention.

FIGS. 15A & 15B depict illustrative methods of prefetching information according to an embodiments of the present invention;

FIG. 16 is a block & flow diagram that illustrates a relatively inefficient method of recursively crossing process boundaries to gather UI-element information; and

FIG. 17 is a block & flow diagram that illustrates an efficient method of gather UI-element information according to an aspect of the present invention.

### DETAILED DESCRIPTION OF THE INVENTION

The present invention provides a novel method and apparatus for retrieving and using information associated with a target user interface by bundling UI-element-attribute information with a the results of an element-information request, and returning the bundle to a client application rather than just the element itself.

The present invention will be better understood from the detailed description provided below and from the accompanying drawings of various embodiments of the invention. The detailed description and drawings, however, should not be read to limit the invention to the specific embodiments. Rather, these specifics are provided for explanatory purposes that help the invention to be better understood.

Specific hardware devices, programming languages, components, processes, and numerous details including operating environments and the like are set forth to provide a thorough understanding of the present invention. In other instances, structures, devices, and processes are shown in block diagram form, rather than in detail, to avoid obscuring the present invention. But an ordinary-skilled artisan would understand that the present invention may be practiced without these specific details. Computer systems, servers, work stations, and other machines may be connected to one another across a communication medium including, for example, a network or network of networks.

Raw-Tree Generator

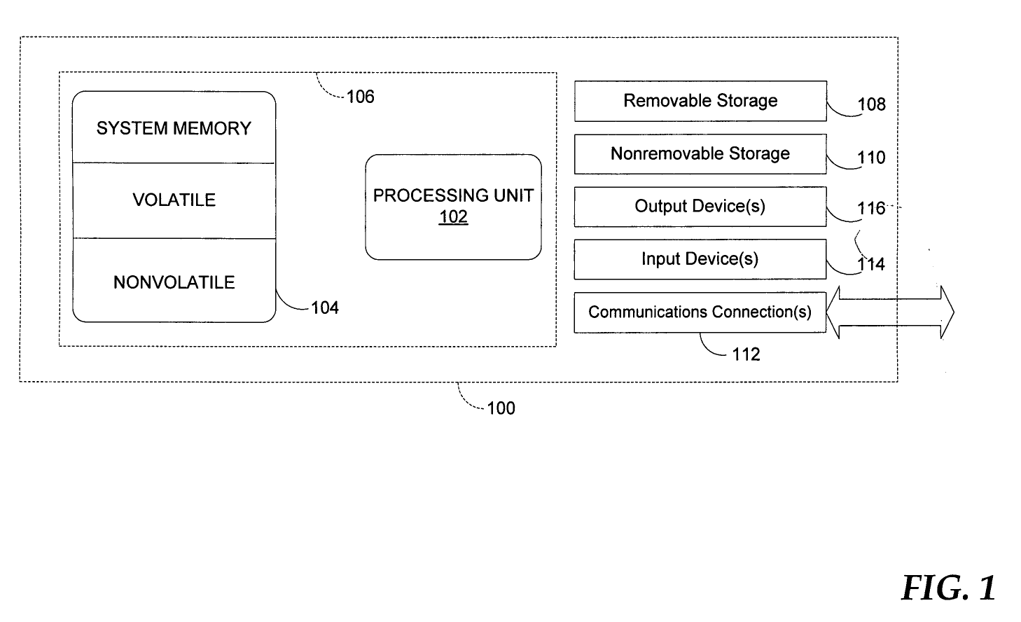

With reference to FIG. 1, an exemplary system for implementing the invention includes a computing device, such as computing device 100. Computing device 100 may take the form of a conventional computer, handheld computer, notebook computer, server, workstation, PDA, or other device capable of processing instructions embodied on one or more computer-readable media. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This basic configuration is illustrated in FIG. 1 by dashed line 106.

Device 100 may also have additional features that offer a variety of functional aspects. For example, device 100 may include additional storage (removable and/or non-removable) including, but not limited to, magnetic, optical, or solid-state storage devices. Exemplary magnetic storage devices include hard drives, tape, diskettes, and the like. Exemplary optical-storage devices include writeable CD-ROM, DVD-ROM, or other holographic drives. Exemplary solid-state devices include compact-flash drives, thumbdrives, memory-stick readers and the like. Such additional storage is illustrated in FIG. 1 by removable-storage component 108 and nonremovable storage 110.

Computer storage media include volatile and nonvolatile, removable and non-removable media implemented in any method or technology for storage of information such as computer-readable instructions, data structures, program modules, and the like. Memory 104, removable storage 108 and nonremovable storage 110 are all examples of storage media. Storage media include, but are not limited to, RAM, ROM, EEPROM, flash memory, CD-ROMs, Digital Versatile Discs (DVD), holographic discs, or other optical storage, magnetic cassettes, magnetic tape, magnetic disk storage or other magnetic storage devices, solid-state media such as memory sticks and thumbdrives, or any other medium that can be used to store information and that can accessed by device 100. Any such computer-storage media may be part of device 100.

Device 100 may also contain communications connection(s) 112 that allow the device to communicate with other devices. Communications connection(s) 112 are an example of communication media. Communication media typically embody computer-readable instructions, data structures, program modules, or other data in a modulated data signal such as a carrier wave or other transport mechanism and includes any information-delivery media. The term “modulated data signal” includes a signal that has one or more of its characteristics set or changed in such a manner as to encode information in the signal. By way of example, and not limitation, communication media include wired media such as a wired network or direct-wired connection, and wireless media such as acoustic, RF, infrared, spread spectrum, the many flavors of 802.1 technologies (802.1a, 802.1b, 802.1g), and other wireless media. The term “computer-readable media” as used herein includes both storage media and communications media.

Device 100 may also have input device(s) 114 such as a keyboard, mouse, pen, voice-input device, touch-input device, etc. Output device(s) 116 such as a display, speakers, printer, etc. may also be used in connection with device 100 or incorporated within it. All these devices are well know in the art, need not be discussed at length here, and are not discussed at length so as to not obscure the present invention.

As one skilled in the art will appreciate, the present invention may be embodied as, among other things: a method, system, or computer-program product. Accordingly, the present invention may take the form of a hardware embodiment, a software embodiment, or an embodiment combining software and hardware. In a preferred embodiment, the present invention takes the form of a computer-program product that includes computer-useable instructions embodied on one or more computer-readable media.

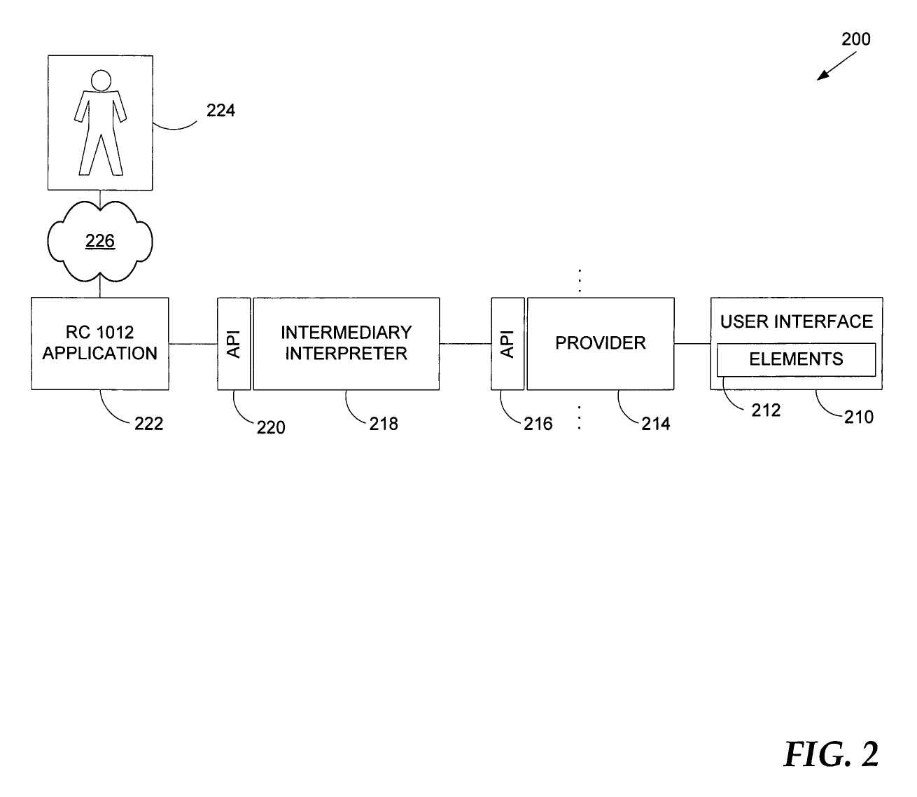

Turning now to FIG. 2, a dataflow diagram in accordance with an embodiment of the present invention is referenced generally by the numeral 200. FIG. 2 includes a user interface 210 that has one or more elements 212. Exemplary items that fall within the scope of elements 212 include any user-interface object that can be clicked on by a pointing device, typed in, given the focus, or activated in a user interface environment. Exemplary elements 212 include a window, a button, a toolbar, a scrollbar, a hyperlink, a text item, an icon, and the like. An element may also include a component that provides auditory or physical feedback, such as an audio-feedback message or a peripheral device that provides physical feedback such as a vibrating mouse.

User interface 210 is coupled to a provider 214, which has associated with it a provider-side API 216. The provider side API 216 is coupled to an intermediary interpreter 218, which has associated with it a client-side API 220 and one or more consolidators (explained in greater detail below). The client-side API 220 is coupled to a client 222, which is finally interacted with by a user 224 though various intermediary components represented by cloud 226.

As used herein, a “provider,” such as provider 214, is a software component that retrieves hierarchal-component information. The information needed to extract information from various types of controls is packaged within one or more providers. A logical tree is an exemplary way to store hierarchal structural information. Provider 214 may employ a variety of technologies to extract information from a specific element and pass that information on to intermediary interpreter 218. Different elements may have different providers associated with them. Thus, if information about a button is desired, a first provider may be used, whereas a different provider may be used to retrieve information about either a different type of button or a different type of element. In a preferred embodiment, providers work at a control level rather than at an application level. Provider 214 performs several functions not limited to registering itself with intermediary interpreter 218 including providing information related to an element's properties, providing information related to an element's patterns, raising events, and exposing structural elements such as relative links.

Although “properties” and “patterns” which will be explained in greater detail below, properties generally describe a user interface corresponding to a node and patterns generally describe functionality that enable interaction with a node. Different techniques may be employed to gather information from different components. In a first technique, internal APIs may be used to gather desired data. In other applications, a messaging service may be employed or the element's object model, or internal state, may be accessed directly. As reflected by the ellipses shown in FIG. 2, operating environment 200 may include any number of providers 214 and corresponding provider APIs 216.

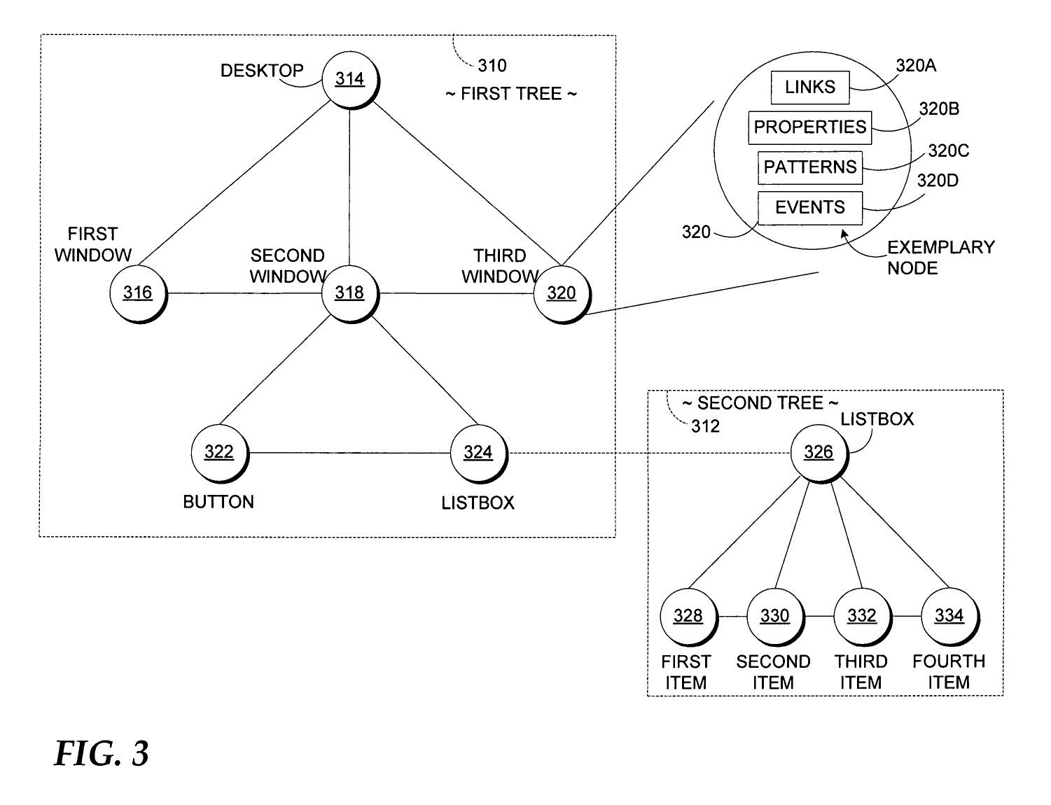

Intermediary interpreter 218 receives information provided by one or more providers 214 and presents that data in such a way that requesting component 222 sees one seamless hierarchal structure. A “tree” refers to a logical data arrangement where the data arrangement assumes a hierarchal nature. The functionality provided by intermediary interpreter 218 will be explained in greater detail with reference to FIGS. 3 through 9.

Turning now to FIG. 3, a first tree 310 is depicted along with a second tree 312. As with all trees described and illustrated herein, trees 310 and 312 are illustrative in nature and should not be construed as a limitation of the present invention. In practical application, trees are often significantly more complicated and may have several tens or hundreds of nodes spanning several layers. The foregoing tree illustrations are provided in a simplified format so as to not obscure the present invention. Tree 310 provides an illustration of how a desktop that has certain elements may be represented as a logical tree.

As shown, the desktop includes three windows where the second window has a button and a listbox. Thus, the desktop itself is represented by node 314. The three windows that appear on the desktop are represented by child nodes 316, 318, and 320, which respectively correspond to a first window, a second window, and a third window. The second window, represented by node 318, includes a button and a listbox, which are represented by respective nodes 322 and 324.

Programming resources and operating efficiencies limit the amount of information contained in any single tree. Thus, a variety of logical trees are used to represent various levels of granularity in a user interface. FIG. 3 illustrates that the granularity of desktop tree 310 stops with a label of listbox 324. If a requesting application desired information relating to the desktop (e.g., the contents of listbox 324) then that request, in certain situations, may not be able to be fulfilled because desktop tree 310 does not include information relating to the elements within listbox 324. That level of granularity is provided in the listbox tree 312. Typically, separate APIs are used to access each tree.

As shown, listbox 312 includes a listbox that has four items. The listbox is represented by node 326 and each of its four corresponding list-box elements is represented by child nodes 328, 330, 332, and 334. The present invention provides a method for merging logical trees, and in this example, would provide to a requesting component a representation that would appear to be a single tree including granularity encompassing the desktop representation all the way down to the list-box elements.

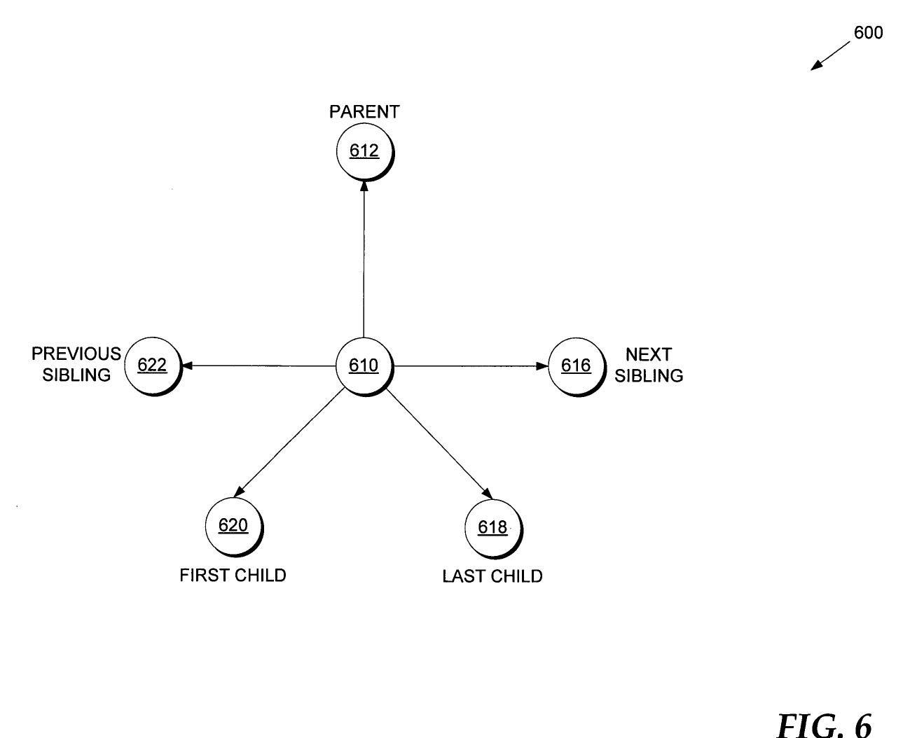

With further reference to FIG. 3, node 320 is arbitrarily selected as an exemplary node used throughout the description of the present invention. Shown in blowup form, exemplary node 320 includes a set of relative links 320A, a set of properties 320B, and a set of patterns 320C. Relative links 320A refer to a description of the relative links associated with a specific node, which relative links will be described in greater detail with reference to FIG. 6. Properties 320B describe element attributes. Exemplary element attributes include an indication of an element's position, an element's name, a description of an element's type (e.g., whether the element is a button, a window, a listbox, a combo box, etc.), whether the element is read-only, whether the element can receive the focus, whether the element is enabled or disabled, and the like. Although other terms may be used in the art, properties 320B are intended to include the litany of other attributes in addition to the exemplary attributes provided.

Patterns 320C enable requesting component 222 to access the broad functionality associated with a control or user-interface element. As would be appreciated by one skilled in the art, patterns 320C can be interfaces where different patterns represent different types of functionality. In this way, interfaces are used in programming languages to access functionality of elements. For example, buttons and similar controls that can be pressed to issue commands support a pattern that allows a client to press the button or otherwise issue an associated command. Listboxes, comboboxes and other controls that manage selection of child items support a pattern that allows a requesting component to request changes to the selection. Controls that have multiple aspects of functionality can support multiple patterns simultaneously. Patterns 320C are an example of the attributes/information associated with a node, and should not be construed as limitation of the present invention. Where such information exists, however, the present invention provides for its merging, as will be described in greater detail below.

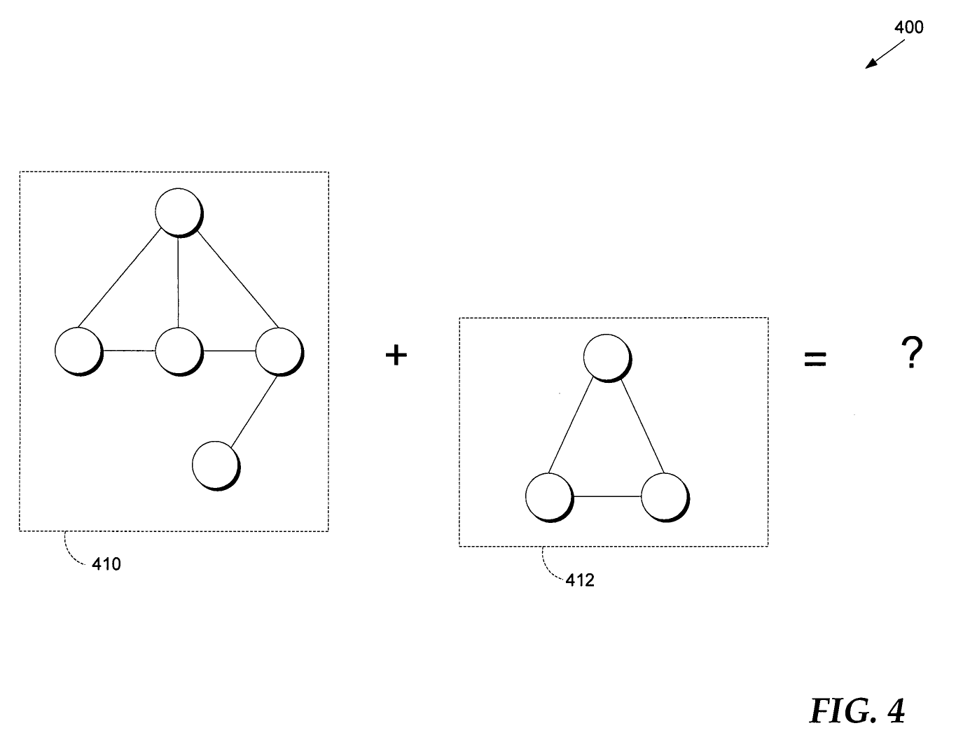

FIG. 4 visually depicts one of the problems to be solved by the present invention. That is, FIG. 4 illustrates that two hierarchal structures, trees 410 and 412, are to be logically merged.

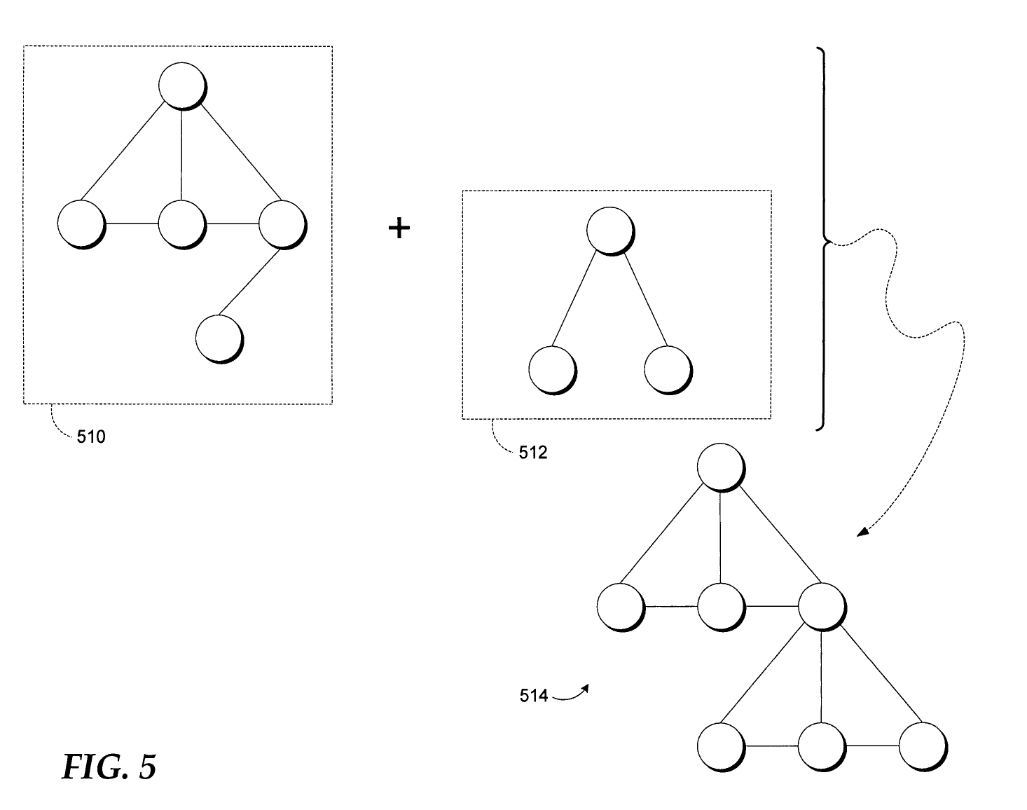

FIG. 5 illustrates combining a first logical tree 510 with a second logical tree 512 to produce what appears to requesting component 222 as a single tree 514. Tree 514 is depicted as a representation of how requesting component 222 views the combination of trees 510 with 512 and is not intended to convey that tree 512 is actually grafted onto tree 510. Rather, as will be discussed in greater detail below, an object of the present invention is for requesting component 222 to be presented with a representation that appears to be a single logical tree, but which in fact is an aggregation of multiple trees that includes referential identifiers to create the appearance of a single tree. Moreover and in addition to aggregating the relative links is trees 510 and 512, the set of properties and patterns associated with the merged node will include the aggregated properties of the corresponding nodes from trees 510 and 512. But combining tree 512 with tree 510 is a nontrivial task. Each node of FIG. 5 can potentially refer to five different nodes as depicted in FIG. 6.

FIG. 6 illustrates an exemplary set of hierarchal links associated with a node. A central node 610 may have at least one parent node 612, a next-sibling node 616, a last child node 618, a first-child node 620, and a previous-sibling node 622. FIG. 6 illustrates that a single node may refer to at least five different nodes. Although not shown, each of the five different nodes may also refer to other nodes. That is, FIG. 6 does not illustrate potential bidirectional relationships associated with each node.

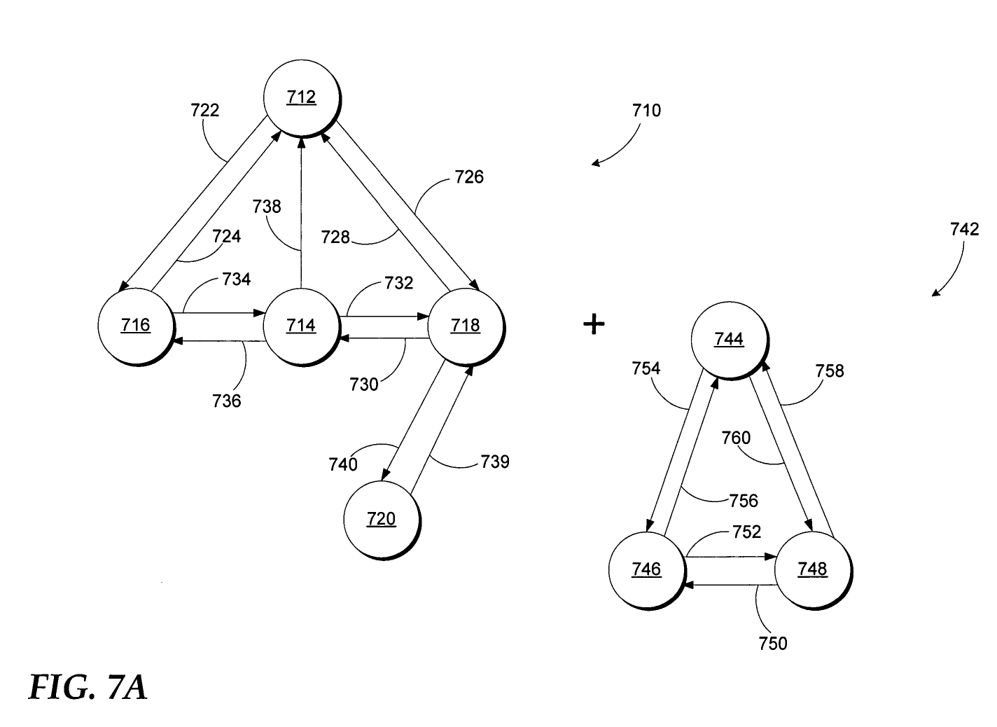

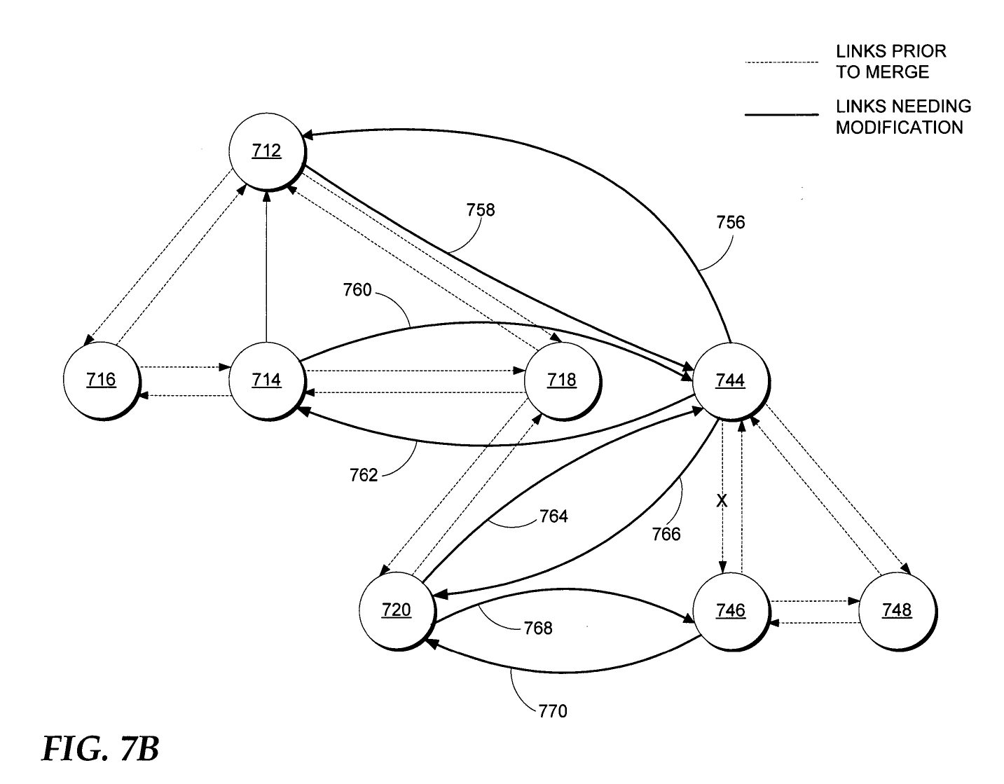

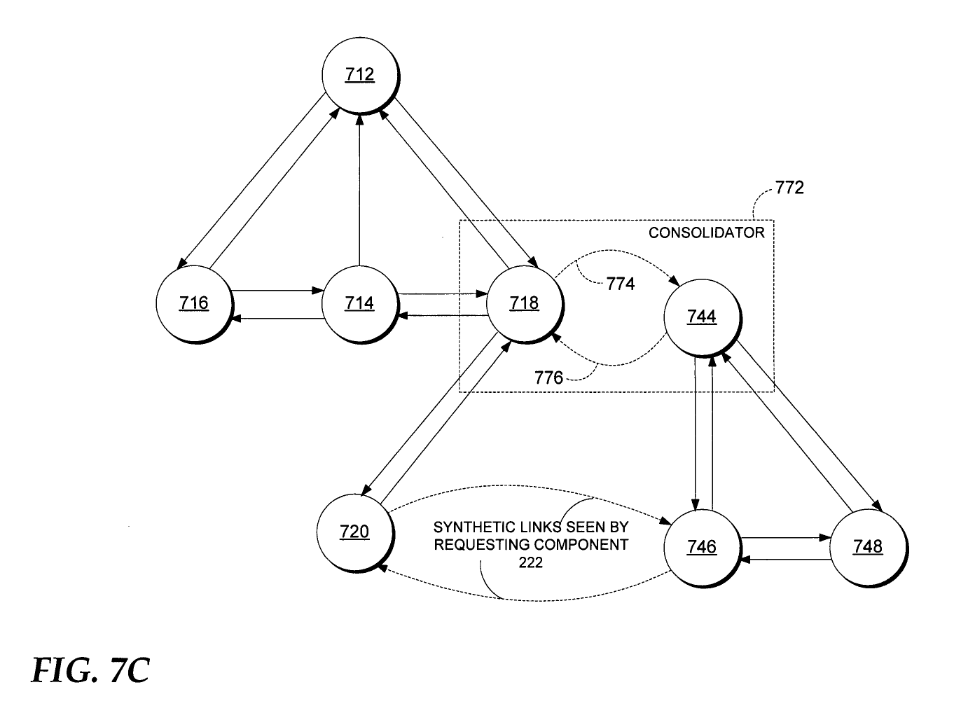

FIG. 7A is a diagram that illustrates in greater detail relationships between the nodes of two trees to be combined. A first tree 710 is shown that has a top node 712 and a child node 714, which has a previous-sibling node 716 and a next-sibling node 718. Node 718 has a child node 720. Nodes 716 and 718 are also first-child and last-child nodes of parent node 712. Links are depicted between the various nodes of tree 710 that enable navigation between the nodes (tree traversal). Links 722 and 724 relate data between nodes 712 and 716. Links 726 and 728 establish a parent-child relationship between nodes 712 and 718.

Relative links 730 and 732 establish a previous- and next-sibling relationship between nodes 714 and 718. Links 734 and 736 provide a previous- and next-sibling relationship between nodes 716 and 714. Node 714 is denoted as the child node 712 by link 738. Links 739 and 740 provide a parent-child relationship between nodes 718 and 720. Second tree 742 is composed of three nodes—parent node 744, first-child node 746, and last-child node 748. A sibling relationship is established between nodes 746 and 748 by links 750 and 752. Relative links 754 and 756 establish a first-child relationship between nodes 744 and 746. Links 758 and 760 establish a last-child relationship between nodes 744 and 748.

One method for representing tree 712 and tree 742 as a single tree would be to actually graft tree 742 on to tree 710 and then update all the links and notations associated with the affected node(s).

FIG. 7B illustrates a portion of the complexities involved in actually grafting tree 742 on to tree 710. FIG. 7B does not illustrate all of the complexities associated with grafting tree 742 onto tree 710. Rather, FIG. 7B illustrates merely a portion of the complexities that would need to be contemplated and resolved by a developer in connection with grafting tree 742 onto tree 710. In FIG. 7B, the links in a state prior to a tree merge are reflected by dashed lines. The links requiring modification are shown in a heavier line width.

If tree 742 were grafted onto tree 710, then links 756 and 758 would need to be established between nodes 712 and 744 to establish a proper parent/child relationship. A determination would also need to be made as to whether nodes 718 or 744 would be designated as a last child. Links 760 and 762 would need to be established and reconciled so as to establish a sibling relationship between nodes 714 and 744. Node 720, which previously was a lone child node of 718, would need to be updated as a first-child node and as a new previous-sibling node, associated with node 746. Links 764 and 766 would need to be added and reconciled to establish the parent/child relationship between nodes 744 and 720. Links 768 and 770 would need to be established between nodes 720 and 746 to establish a sibling relationship. Node 746, which used to be a first child, would need to be updated to a next and previous sibling.

As previously mentioned, other issues associated with grafting tree 742 onto tree 710 need to be reconciled, but FIG. 7B illustrates a portion of the complexities associated with actually merging two even relatively simple trees. If trees 710 and 742 were more complex than having merely five nodes and three nodes respectively, then even more links, properties, patterns, and notations would need to be updated in connection with merging the two or more trees.

In a method where tree 742 is actually grafted onto tree 710, the task of updating the various links and corresponding properties would fall to the providers 214. If the providers 214 do not accurately update all of the applicable links 320A, properties 320B, and patterns 320C, then requesting component 222 will not be able to navigate through the resulting tree. For instance, consider nodes 720 and 746 of FIG. 7B. If node 720 is not updated to be the first child of node 744, then requesting component 222 may receive bad information that node 746 is the first child of node 744, when it is not. To the extent an application relied on a correct designation of the first child of node 744, that application would produce erroneous results.

In another example, consider links 768 and 770 between nodes 720 and 746 in FIG. 7B. If nodes 768 and 770 are not correctly established, then requesting component 222 may hit a logical wall and be prevented from navigating out of the resulting tree. If an application, such as requesting component 222, cannot navigate out of a logical tree structure, then the application may hang, thereby preventing control from being returned to user 224.

The complexity associated with coding one or more providers 214 capable of updating all of the relevant links 320A, properties 320B and patterns 320C is virtually overwhelming. Such a task would be exacerbated by the fact that different trees have different ways of storing links. That is, a first tree may designate relative links 320A in a first manner but a second tree may designate relevant links 320A in a second manner. Actually merging the two trees would be difficult because of the disparate methods employed for storing links 320A. According to a preferred embodiment, the present invention provides a set of referential links between a hosted and a hosting node as illustrated in FIG. 7C.

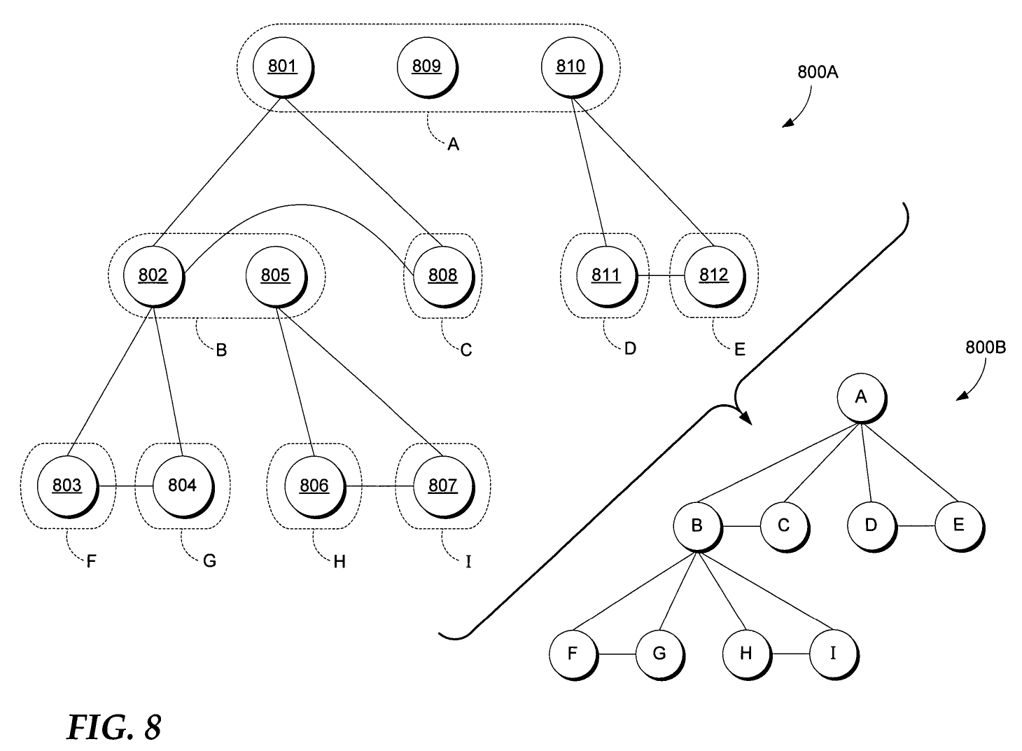

As shown, FIG. 7C illustrates that intermediary interpreter 218 merges the patterns, properties, and links of nodes 718 and 744. This merging is referenced generally by consolidator 772. As previously mentioned, intermediary interpreter 218 includes one or more consolidators. A consolidator is a representation of a single node (as illustrated in FIG. 8) or a logical merge of two or more nodes. Consolidators embrace technical schemes where a user interface, such as user interface 210, is composed of heterogeneous trees of elements 210 and enables a client to view these heterogeneous trees as a single tree.

As described above, information for a particular piece of user interface 210 often comes from multiple sources. For example, in the case of a button on a screen, the location, visual state, enabled/focused information, etc., may come from an underlying user-interface framework. The fact that the element is a button and can be pressed is information derived from the control itself. Still further, another software application may have information about the purpose of this button within the context of the overall application. Intermediary interpreter 218 remedies the information disparities by logically merging properties and patterns together using a method that employs a multiple-provider architecture.

In this manner, a first referential link 774 indicates that node 744 is being hosted by node 718. A second referential link 776 indicates that node 744 is being hosted by node 718. Incident to receiving a request from requesting component 222, intermediary interpreter 218 identifies one or more trees that are to be represented as a single tree. Intermediary interpreter 218 then provides first and second referential links 774 and 776. Consolidator 772 then acts as a merging agent between the two trees. For example, when node 712 attempts to communicate with its last child node, intermediary interpreter 218 provides feedback to the relevant nodes that the nodes are communicating with a set of merged nodes. Thus, requesting component 222 would perceive communications pathways between nodes 718 and 748 of FIG. 7C because consolidator 772 makes nodes 718 and 744 appear to be a single entity rather than as two nodes. Consolidator uses referential links 774 and 776 as a source of information to represent nodes 718 and 744 as a single node. Accordingly, a data structure is provided to requesting component 222 composed of a first representation of tree 742 and a second representation of tree 710 to make the two representations appear as a single hierarchal structure to requesting component 222.

A benefit of this approach is that it simplifies the task of providing information to a requesting component, such as requesting component 222. Each provider need only expose the information it is aware of, allowing other providers to provide other information. No longer do the providers 214 need to facilitate subclassing or wrapping existing providers to navigate the hierarchal representation. The respective consolidators obtain links 320A, properties 320B and patterns 320C of nodes 718 and 744 such that a client sees only a single node with all the properties, patterns and children from all of the providers 214.

In a preferred embodiment, providers are arranged in order from lowest to highest—the lowest corresponding to the host user-interface component, the highest corresponding to the hosted user-interface component. The terms “lowest” and “highest” as used herein are not limitations but are used to define end points. Conceptually, however, higher providers can be thought of as being stacked on lower ones, with the higher ones taking precedence.

Additional providers can be employed in connection with some embodiments of the present invention to allow software applications or elements to add additional providers. Including these additional providers is optional and should not be construed as a limitation of the present invention. A first exemplary function offered by an illustrative additional provider is to add more information from an application and can be used where an application has additional knowledge that it wishes to expose to intermediary interpreter 218. These providers can be referred to as “override providers” and are logically denoted with the highest precedence. Other providers can add default information for certain user-interface types. For example, most windows of a user interface are capable of containing scrollbars. A “default” provider can be added to provide these scrollbar-related properties so that other providers do not have to. Requesting component 222 sees the aggregated result. These providers preferably take on a lower precedence order. Also, “repositioning providers” allow some elements to add providers specifically to influence the shape of a tree.

In a preferred embodiment, intermediary interpreter 218 constructs sets of providers for a particular user-interface element and treats all providers the same irrespective of what their purpose is, where they come from, or how many providers are present.

To determine an information set such as properties 320B or patterns 320C, intermediary interpreter 218 queries each provider to determine the set that it supports. It then combines the results with the results from the other relevant providers. Duplicate entries are removed. The result is that requesting component 222 sees the union of properties from all providers.

To determine a specific property or pattern, intermediary interpreter 218 queries each provider, from the highest to the lowest, for the requested data (such as a property like “Name,” or a pattern like “InvokePattern,” which is an object that represents the ability to push a button, for example). When intermediary interpreter 218 receives an affirmative response from a first provider in sequence, it returns those results to requesting component 222 without asking the providers in a preferred embodiment.

Traversing a Tree

Similar to the method for aggregating properties 320B, intermediary interpreter 218 locates parent nodes from the highest to the lowest in a preferred embodiment.

Intermediary interpreter 218 combines child nodes by exposing the children of the lowest providers prior to those of the highest in a preferred embodiment. In alternative embodiments, the order can be reversed as long as the order chosen is employed consistently. When the identification of a first child is requested, intermediary interpreter 218 iterates over the providers from lowest to highest until it identifies one that has a first child, and then uses that. Identifying a last child is similar, except that intermediary interpreter 218 iterates over the providers in the reverse direction—from highest to lowest.

Identifying siblings is somewhat more complicated and will first be described generally and then illustratively with reference to FIG. 8. If intermediary interpreter 218 were to simply look for the first node that had a response for the next or previous link as it does with a parent and first/last child, inconsistencies may develop in the resulting tree. To identify child nodes, intermediary interpreter 218 first determines which node can identify the respective parent. Intermediary interpreter 218 then queries that node for the next or previous sibling, ensuring a consistent tree. If that node replies with a positive response, then the returned node is communicated back to the client.

If the node replies that it does not have a sibling, then processing is not completed. The identification mark could simply be at the end of one provider's collection of children. The parent node may have other providers that are providing other children that should be treated as siblings. Accordingly, intermediary interpreter 218 navigates to the parent and then determines which of the providers in that parent sourced the navigation. Traversal advances in the appropriate direction of the parent's provider list (lowest to highest if looking for next sibling) until the next provider that has children is identified. Once identified, that parent's first child is identified as a next sibling. Similarly, its last child can be identified as a previous sibling if a previous sibling was being sought.

To further explain the methods described above, an example is provided here with reference to FIG. 8. FIG. 8 depicts two trees, 800A and 800B. In FIG. 8, the nodes correspond to providers. Twelve providers are shown as nodes 801-812. Tree 800A is composed of three providers, 801, 809, and 810, logically merged by a consolidator A. Two providers, 802 and 805, are logically merged by consolidator B and appear as a first child of consolidator A. Providers 804, 806-808, and 811-812 are arranged as shown with corresponding consolidators to describe methods consistent with this illustrative embodiment. Each consolidator contains references to one or more providers and can extract information from the providers for a particular user-interface element. Given one provider in a set, the respective consolidator can determine the others by following the referential links (such as links 774 and 776 of FIG. 7C). Tree 800B represents how requesting component 222 sees tree 800A according to the method and data structures of the present invention.

Two main consolidators are depicted in FIG. 8, consolidator A (which logically merges data from three providers) and consolidator B (which logically merges data from two providers). Assume requesting component is at consolidator B within tree 800A and the “next child” is to be identified. First, the provider is identified that knows who the parent is. In this case, provider 802 knows who the parent is. Thus, provider 802 is then queried for its next sibling, responding with “808.” From this information, consolidator C is constructed and node 808 is identified.

Now assume that the next child is again to be identified. First, the present invention determines which provider knows the parent. The provider that knows the parent is provider 808. Provider 808 is then queried for its next sibling. This time it cannot identify a next sibling. Accordingly, navigation is made up the tree to parent provider 801. Consolidator A is used to determine which provider (801, 809, or 810) was the applicable parent. In this case, that parent is provider 801. Next, children are attempted to be identified. Provider 809 is queried but passed over because it has no first child. Provider 810 is queried and indicates that it does have children. Further, provider 811 is identified as a first child and consolidator D is constructed. In doing so, traversal has been made from B to C to D. From the perspective of requesting component 222, tree 800A appears as though there was a link between C and D even though those providers may not be aware of one another. This apparent relationship is illustrated in tree 800B. The process described above allows for generic tree traversal, regardless of the starting node.

Certain types of traversal allow the process to be simplified. For example, to identify all the children of node A, the present invention can simply query each of its providers for their children and union the resulting set together. With continuing reference to FIG. 8, consider consolidator A. Node 801 would return {802, 808}, from which consolidators B and C would be constructed. Node 809 would return an empty list. Node 810 would return {811, 812}, from which consolidators D and E would be constructed. Aggregating these results yields the child list {B, C, D, and E}.

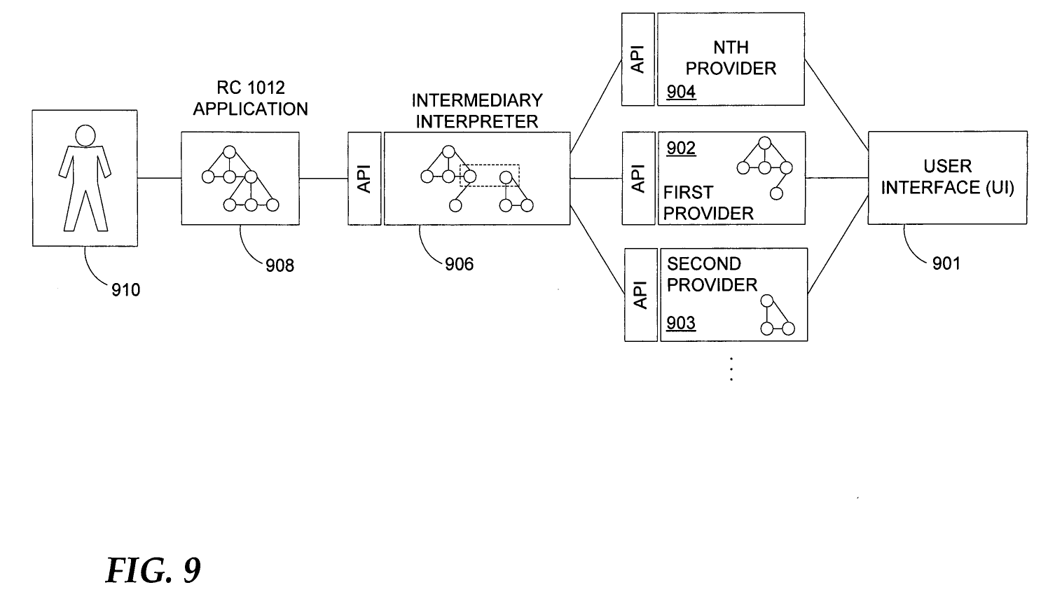

Each of the aforementioned embodiments produces a substantially similar result, which is represented generally in FIG. 9. FIG. 9 depicts a user interface 901 in connection with a first provider 902, a second provider 903 and an n^{th} provider 904. The n^{th} provider 904 illustrates that any number of providers can be used in connection with the present invention. Providers 902, 903, and 904 have corresponding application program interfaces as shown. Each of the providers is coupled to an intermediary interpreter 906, which through its corresponding API communicates with requesting component 908. Requesting component 908 is used by a user 910. Consider an example where user 910 desires that certain components be enlarged or highly contrasted when selected. When user 910 engages a certain action that is supposed to trigger an element-presentation change, requesting component 908 will request information related to a user-interface element to be manipulated. Thus, intermediary interpreter 906 includes a set of instructions that provide the reception of a request for information related to explain one or more elements of user interface 908. Intermediary interpreter 906 also includes a second set of instructions that identifies the various hierarchal trees capable of satisfying a request from requesting component 222. In this example, intermediary interpreter will gather its data from first provider 902 and second provider 903. Using one or more of the technologies described above, intermediary interpreter 906 will utilize a set of instructions to represent the hierarchal structure from first provider 902 and the hierarchal structure of provider 903 to assimilate a representation that makes the respective trees appear to requesting component 908 as a single tree. Intermediary interpreter communicates the representation created to requesting component 908. Requesting component 908 is then provided with a representation that appears to be a single hierarchal structure, which can be used to manipulate the desired user-interface elements. Requesting component 908 is provided with a uniform tree of logical elements and is not aware that a first logical element is receiving properties from a first source and its children or siblings are receiving properties from other sources. This method greatly simplifies the means by which requesting component 908 needs to employ to manipulate desired user-interface elements.

Custom Views and Presentation

As previously mentioned, the prior art does not permit conditions to be sent from a requesting component and thus precludes the possibility of providing customized or predefined views of a raw tree. The present invention solves this problem by providing for the reception of conditions from a requesting component so that a customized view of a set of UI elements can be presented to the requesting component. According to one aspect of the present invention, requesting components (clients) view the UI elements as a set of automation elements that are arranged in a tree structure.

The phrase “automation element” is a proverbial rose that may be known by many names, but is used herein only for referential and explanatory purposes and should not be construed as a term of art or limitation of the present invention. As will be explained in greater detail below, automation element is a mechanism used by an API to expose a node of a logical tree. The automation element provides a way of exposing that node to a requesting component, which can be an application, module, set of instructions, code segment, and the like. As described above, the present invention combines into a unified tree UI element structure of disorganized trees to facilitate easy interaction between a set of UI elements and a requesting component.

The concept of a node is used in the model described herein. Automation element is the way of exposing that model to a requesting component. Thus, the basic type of object that a requesting component interacts with is referred to as an automation element. An instance of this type represents an element that actually appears on a screen or user interface.

Requesting components view UI elements on a desktop as a set of automation elements that are arranged in a tree structure. A root automation element represents a current desktop, which has child automation elements that represent an array of types of UI elements, such as windows, menus, buttons, toolbars, list boxes, radio boxes, combo boxes, menu items, icons, scrollbars, rectangles, and images that make up buttons and toolbars, hyperlinks, etc. Thus, even a button, which does not necessarily contain any items, may have child automation elements that represent the basic UI components that comprise the button, such as text and rectangles.

Tree navigation is accomplished in association with a component referred to herein as “tree walker,” again an internal term simply chosen for referential and illustrative purposes. A tree walker component allows a requesting component to filter a raw tree so that the tree appears to contain only automation elements of interest to the requesting component. It then walks that view of the tree by stepping by one automation element to another in a specified direction, such as parent, first child, next sibling, etc. For example, a requesting component could walk a view of the tree that contains only elements that are marked as being controls; or a requesting component could walk a view of the tree that contains only elements that are both visible and have names assigned to them. Thus, the present invention includes the ability to evaluate multiple conditions against several attributes associated with various nodes or automation elements.

In a preferred embodiment, an automation-element tree is not necessarily maintained as a data structure (although it could be). Rather, it preferably reflects a requesting component's view of the world as it steps from one automation element to another in a specified direction. Thus, in a preferred embodiment, the present invention only creates automation elements as required, such as when the client walks to them. Navigating in a particular direction reflects an automation element in that direction at a certain point in time. A different value may be obtained by a requesting component at a different time as a result of changes to the tree. Such a change might occur, for example, by a UI element appearing, disappearing, or moving; applications starting up or closing; or items being added to or removed from lists, etc.

In a preferred embodiment, an automation-element object represents a particular piece of UI, but is not the actual UI itself. For simplicity sake, and capturing alternative embodiments, it is understood that when reference is made for example to “the automation element that currently has the focus,” such a phrase contemplates meaning “the automation element that represents the UI element that currently has the focus.”

Clients can obtain automation elements in a variety of ways. For example, a requesting component may get the currently focused element using a procedure call to return the currently focused element. Alternatively, a requesting component can reference a point on a screen to determine an automation element. Or, in a final illustrative example, a request can be made for a root element—referred to herein as a “desktop.” This element contains the windows of currently running applications as its children. Once a requesting component has an automation element, it can traverse the element tree to reach other automation elements.

Requesting components may register to receive notifications about changes to the state of a user interface. When such a change occurs, the requesting component is notified of the change and is provided with an automation element indicating the affected part of the UI.

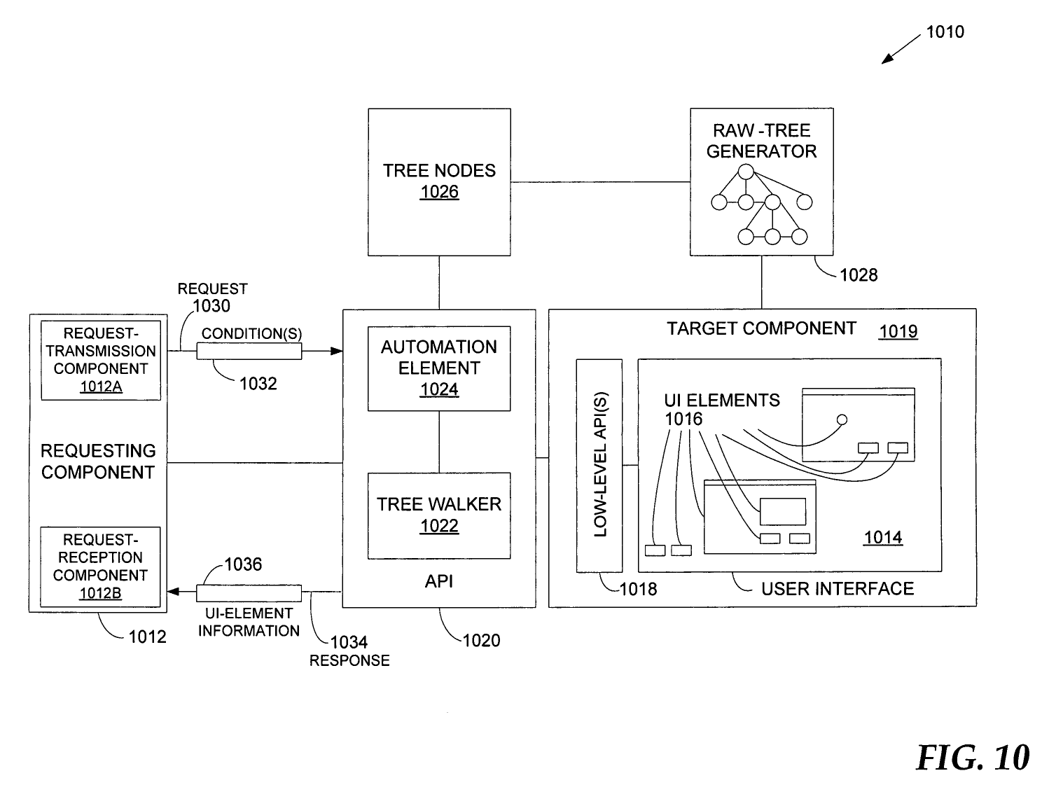

Turning now to FIG. 10, a second illustrative operating environment is depicted and referenced generally by the numeral 1010. Operating environment 1010 includes a requesting component 1012 (which includes a request-transmission component 1012A and a request-reception component 1012B) that requests information related to elements of a user interface 1014. User interface 1014 is composed of a variety of UI elements 1016, which, as previously mentioned, include a litany of objects such as textboxes, buttons, windows, shapes, and images that make up buttons, hyperlinks, etc. A set of low-level APIs 1018 can provide functionality to help retrieve information associated with UI elements 1016.

Low-level APIs 1018 are not a required component of the present invention, and are often subsumed within the meaning of a target component 1019. In this embodiment, target component 1019 includes access to low-level APIs 1018 and user interface 1014. An API 1020 helps facilitate calls between requesting component 1012 and target component 1019. API 1020 includes a set of automation elements 1024 and one or more tree-walker components 1022. So as to not obscure the present invention, reference will be made to various devices in a singular fashion, such as an automation element 1024 or tree walker 1022. But the use of singular instead of plural should not be construed as a limitation of the present invention. API 1020 is in communication with a set of tree nodes 1026, which are nodes of a tree generated by a raw-tree generator 1028, the functionality of which has been described earlier in this disclosure. Raw-tree generator 1028 creates a unified hierarchal representation of UI elements of disparate platforms.

Requesting component 1012 submits a request 1030, which includes a set of one or more conditions 1032. Again, conditions 1032 may be referred to herein in singular fashion to ease explanation, but such reference should not be construed as limited to a singular condition. Indeed, the present invention can evaluate multiple conditions against an entire set of UI elements. API 1020 returns a response 1034, which includes UI-element information 1036. Exemplary UI-element information 1036 can include attributes associated with one or more UI elements. Exemplary attributes include properties 320B, patterns 320C, and links 320A (see FIG. 3).

Properties 320B include such items as a UI-element name, such as “OK,” “submit,” “cancel,” etc. Another illustrative property 320B includes an indication as to whether an element currently has the focus. Those skilled in the art understand that for an element to have the focus it is the object of potential input by either a mouse or a keyboard. Another illustrative property 320B includes an indication as to what type of element the element is, for example, a button, list box, or combo box, etc. Once requesting component 1012 has an automation element 1024, it can use it to obtain information about the state of user interface 1014. As is being described, this state information can be exposed via properties.

In one embodiment, each property has an identifier assigned to it. Exemplary nomenclature may include “automation Element.NameProperty” to refer to the name of a UI element. Similarly, AutomationElement.IsFocused refers to a current focus state of a UI element—“true” if the control is currently focused, “false” otherwise. The illustrative property identifiers referenced herein refer to the concept of the property, not necessarily its current value. To determine the current value of a property, a requesting component preferably employs a method on automation element 1025. For example, to get the name of the currently focused control, a client may use the following illustrative statement:
string name=(string) el.GetCurrentPropertyValue (AutomationElement.NameProperty).

This statement would return a true indication if the currently focused control was an “OK” button, for example. As an alternate form of the above, a more simplified format may be used, such as:
string name=el.current.name.

Other exemplary properties include name, is_focused, is_enabled, control_type, localized_control_type, is_control_element, is_content_element, and keyboard_help_URI. This list is not exhaustive but exemplary in nature.

An automation element may also be associated with one or more patterns 320C. Whereas properties 320B enable requesting component 1012 to discover the current state of the UI, patterns 320C allow a client to interact with the UI, such as UI 1014. Exemplary interactions include invoking an item (e.g., pressing a button, selecting a menu item, or otherwise interacting with the UI that issues a command); selecting or unselecting an item in a list, combo box, or other control; or expanding or collapsing a menu, combo box, or other tree-view item.

Patterns 320C offer the aspect of representing functionality independently of the actual control type. For example, hyperlinks, menu items, and buttons support the “invoke” pattern. This scheme enables requesting component 1012 to access functionality without having to have prior knowledge of the actual type of control. Thus, requesting component 1012 can select or unselect an item irrespective of whether that item is in a list box, a combo box, a tree-view, or some other type of control that supports selection.

An element may support zero or more patterns. Using a pattern is preferably carried out by a two-step process: first, requesting component 1012 determines whether UI 1014 supports the specified functionality. If it does, then it can actually access that functionality. To illustrate by way of example, suppose a client wishes to select an item in a list (assuming it has already obtained an automation element that refers to the desired item). The following code depicted in Table 1 would be illustrative and applicable:

TABLE 1
Exemplary pseudocode for using patterns to select an item in a list

AutomationElement item = ...;
//Got the item, now determine whether it supports the ability to be
selected/deselected:
SelectionItemPattern selection = (SelectionItemPattern)
item.GetCurrentPattern(
SelectionItemPattern.Pattern );
if( selection != null )
{

// yes, this item is selectable - now select it:
// this is the part that actually accesses the functionality
item.Select ( );

}

To press a button, for example, requesting component 1012 would perform a similar two-step process in a preferred embodiment. It would first check that the UI supported the “invoke” pattern, and if an affirmative response is returned, then requesting component 1012 would then actually call the “invoke” method on the invoke pattern to actually press the button.

Exemplary patterns include: the invoke pattern (buttons, menu items, toolbar items); the toggle pattern (the ability to toggle between two or more states, such as checkboxes); the selection pattern (the ability to manage a selection); the selection item pattern (the ability to be part of a selection); the grid pattern (the ability to index children by row and column); the grid item pattern (the ability to determine location within a grid).

As previously mentioned, UI elements 1016 are presented to requesting component 1012 as part of a single tree. In one embodiment, this tree includes all the UI from all the applications of a current desktop. As referred to above, this raw tree includes all elements that are known to the present invention even down to a low level of granularity. This representation would include, for example, elements representing items in a list box, but also the scrollbars on that list box; a button as well as elements representing text and images within the button.

Because this raw tree is potentially at so low a level of granularity, requesting component 1012 would prefer to work with a tree that contains items it is interested in. For example, perhaps requesting component 1012 only wishes to be concerned with items identified as “controls,” for example, list items and buttons, but not the text and images that compose the button. Alternatively, perhaps requesting component 1012 wishes only to be concerned with items identified as “content,” for example, items in a list, but not the scrollbars or scrollbar buttons associated with the list.

The present invention allows just such a thing. That is, the present invention allows clients, such as requesting component 1012, to view a representation of a portion of the raw tree by specifying one or more conditions, such that all elements that do not satisfy the conditions set are skipped over by the present invention. Only elements that satisfy the condition would be presented to requesting component 1012. In a preferred embodiment, the starting node is always included as a representation. One or more conditions, such as conditions 1032, can be specified in terms of properties having specified values—for example, a client may choose to view the tree in such a way that it contains only nodes that have a specific property set to “true.” The present invention would enable the requesting component to traverse a tree using tree walker 1022, which will be described in greater detail below.

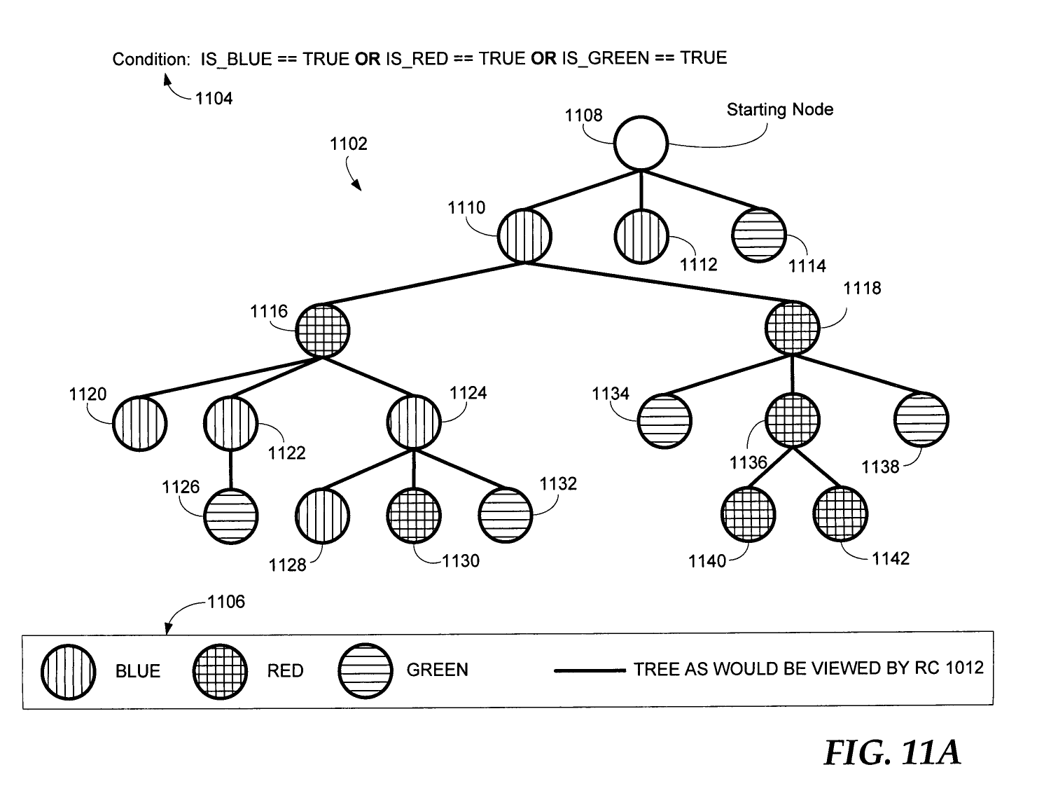

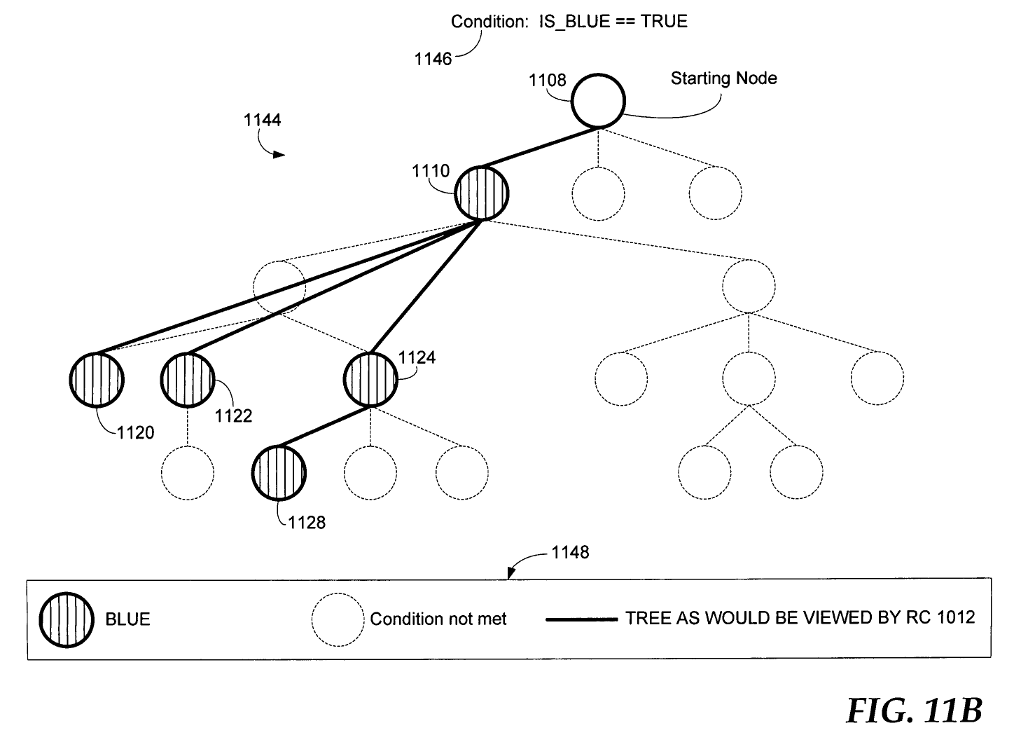

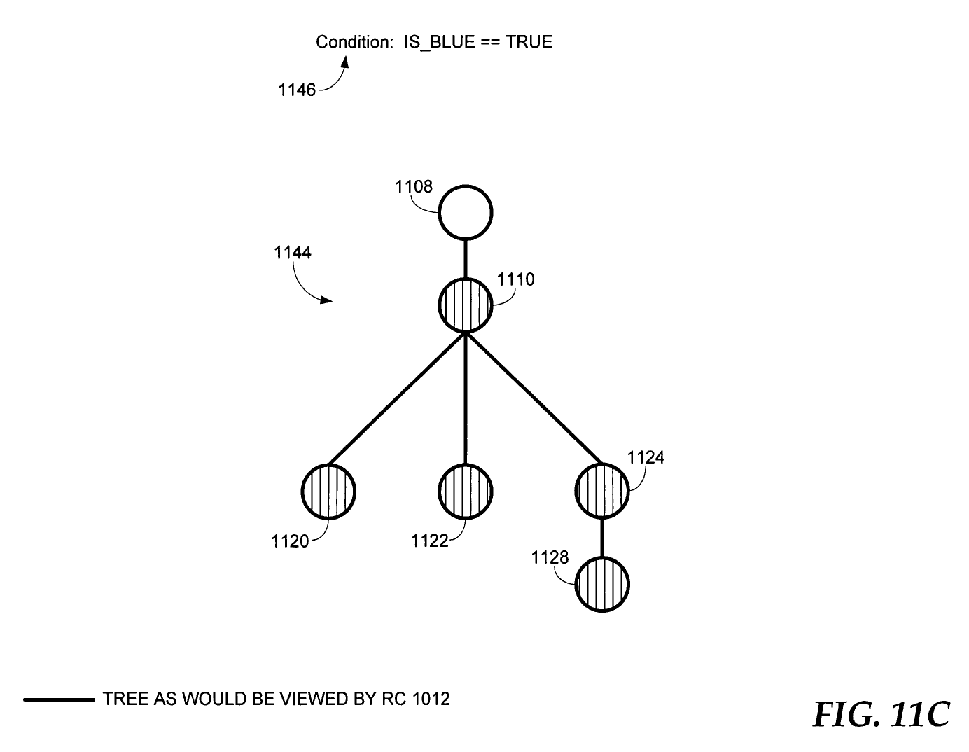

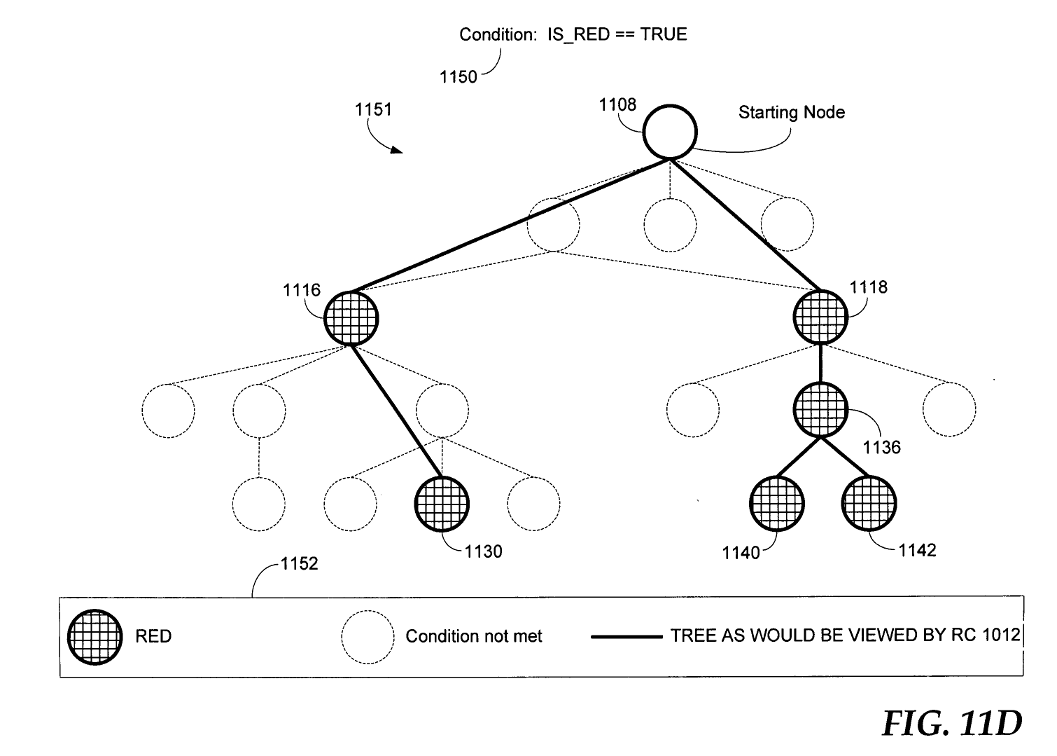

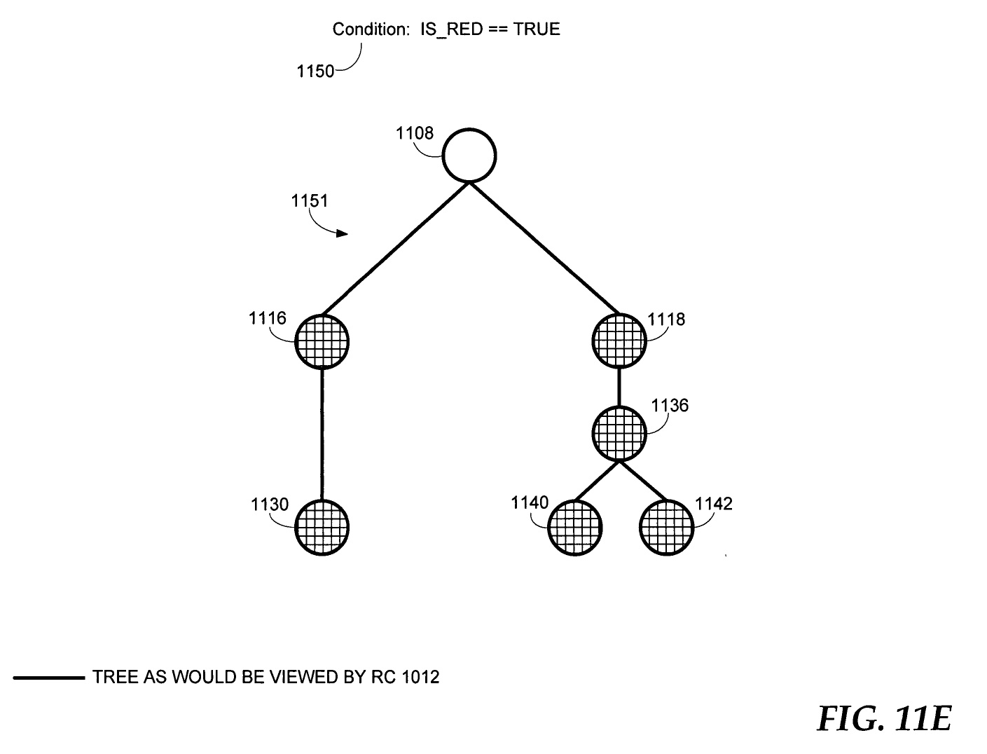

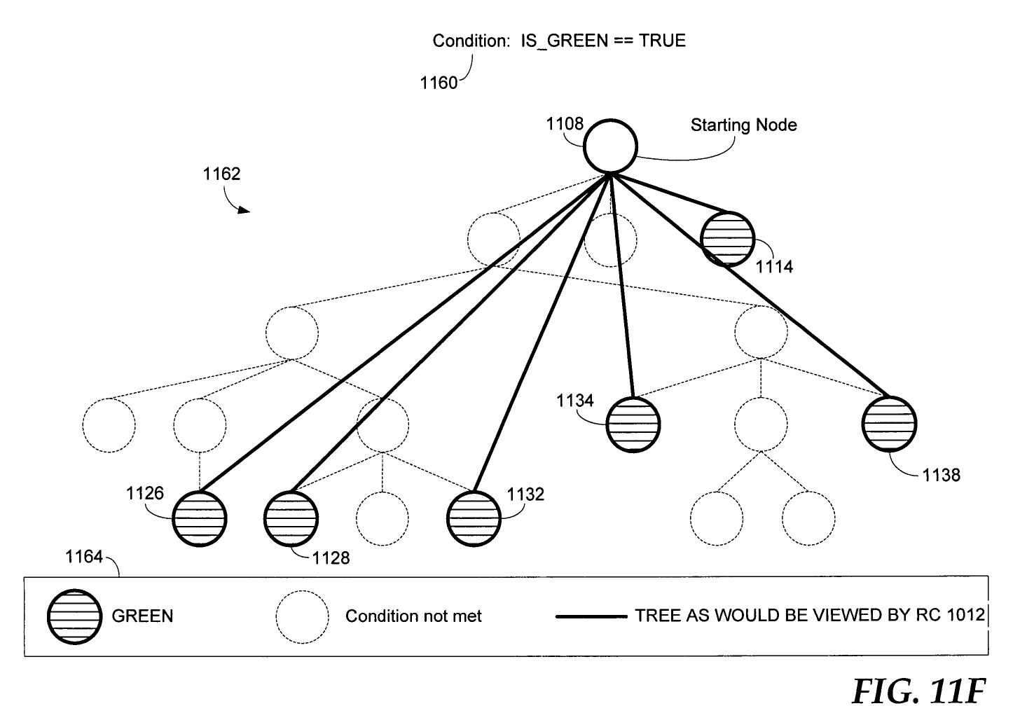

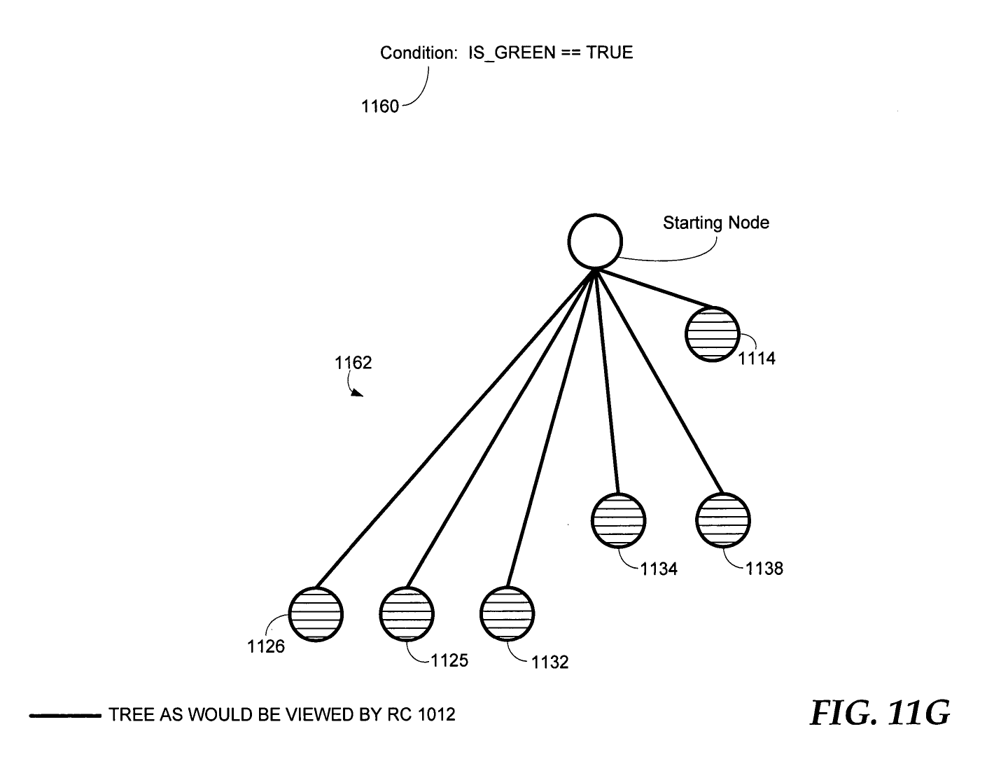

Turning now to FIGS. 11A-11G, various aspects associated with representing a portion of a raw tree subject to conditions 1032 will be discussed. FIG. 11A includes a tree 1102, a condition 1104, and a legend 1106. Tree 1102 would be what has been referred to herein as a raw tree. Here, the condition,
is_blue==true OR is_red==true OR is_green==true

is satisfied according to the illustrative tree 1102. Tree 1102 includes nodes that are blue, red, and green. Vertical hashes represent blue nodes, a grid pattern represents red nodes, and horizontal hashing represents green nodes, as depicted in legend 1106. Starting node 1108 would correspond to a desktop. Children nodes to starting node 1108 include nodes 1110, 1112, and 1114. Node 1110 has two children, 1116 and 1118. Node 1116 has three children, represented as nodes 1120, 1122, and 1124. Node 1122 has a single child 1126. Node 1124 has three children, 1128, 1130, and 1132. Node 1118 has three children, nodes 1134, 1136, and 1138. Finally, node 1136 has two children, 1140 and 1142. Automation element 1024 is used to expose the various nodes to requesting component 1012.

Assume, for example, that requesting component is interested in blue nodes only. Turning to FIG. 11B, a condition 1146 would be submitted by requesting component 1012 indicating that only blue nodes are of interest. The present invention would then prune tree 1102 to produce a tree 1144, which is composed only of blue nodes: 1110, 1120, 1122, 1124, and 1128. As indicated by legend 1148, tree 1144 represented by the heavy-weight lines, is what would be seen by request component 1012. Request component 1012 would be unaware of the red and green nodes, and consequently would not have to include procedures or mechanisms to deal with these nodes. Note that if requesting component 1012 submitted node 1120 as a starting node and requested information regarding the parent of node 1120, then node 1110 would be returned, not node 1116. This is because the present invention would evaluate condition 1146 against node 1116, determine that node 1116 does not satisfy condition 1146, and progress to the next parent, which is node 1110. The present invention would then evaluate condition 1146 against node 1110 and determine that node 1110 does satisfy condition 1146. Therefore, attribute information associated with node 1110 would be returned to requesting component 1012. FIG. 11C more clearly represents tree 1144, not superimposed on tree 1102. Thus, if requesting component 1012 was interested only in blue nodes, instead of having to interact with the complexity of raw tree 1102, it would be presented with a more simple tree, namely tree 1144 of FIG. 11C.

Assume now that requesting component 1012 wishes to only receive information associated with red nodes. Turning to FIG. 11D, a tree 1151 is shown superimposed on tree 1102 subject to condition 1150, which restricts nodes of tree 1102 to only red nodes. The same starting node 1108 is indicated. Thus, instead of having to deal with the complex raw tree 1102, a requesting component would only need to deal with the tree depicted in FIG. 11E, which is considerably simpler than tree 1102.

Assume now that the requesting component wishes to see only green nodes. A tree 1162 is depicted in FIG. 11F as superimposed on raw tree 1102 (represented as dashed lines). Condition 1160 indicates that only green nodes are desired, but any of the aforementioned conditions may be applied to retrieve user elements of interest. Tree navigation is greatly simplified. For instance, assume that node 1128 of FIG. 11F is provided as a starting node. If requesting component 1012 requests the next sibling of node 1128, then node 1132 would be returned rather than node 1130. This is because node 1130 does not satisfy the condition 1160. Requesting component 1012 would see node 1162, as represented in FIG. 11G.

To reduce the level of abstraction associated with FIGS. 11A-11G, consider the exemplary code snippets that follow in Table 2, which highlights navigation of a custom view of a tree, namely a “control” view:

TABLE 2
Exemplary pseudocode to navigate a custom view

AutomationElement start = ...;
AutomationElement el;
TreeWalker walker = TreeWalker.ControlViewWalker;
el = walker.GetParent( start );
el = walker.GetFirstChild( start );
el = walker.GetLastChild( start );
el = walker.GetNextSibling( start );
el = walker.GetPreviousSibling( start );

As illustrated in FIGS. 11A-11G, a custom view is a filtered view of a raw tree that contains only automation elements that satisfy one or more specified conditions. These conditions can be specified by requesting component 1012. In a preferred embodiment, using a custom view does not actually alter the underlying logical tree. Rather, it only affects how requesting component 1012 perceives the structure of the tree. Nodes that do not satisfy the condition are skipped during navigation. Custom views are defined using conditions. These conditions can take on a myriad of forms. For example, a condition may request all UI elements with a specific name. Another condition may request UI elements that have a specific property or attribute. Another condition may request information related to UI elements of a certain shape. It would be impractical to attempt to list all of the different types of conditions that could be provided by requesting component 1012. What is more important is that conditions may be provided by requesting component 1012 and evaluated against a target component 1019. Complex conditions can be constructed using Boolean operators such as “and,” “or,” and “not.” For example, the following condition (illustratively depicted in Table 3) would match elements that have a name of “help” and are not buttons (for example, this may match a “help” menu item, but not a “help” button).

TABLE 3
Exemplary pseudocode to navigate a custom view

Condition testCond = new AndCondition(

new PropertyCondition( AutomationElement.NameProperty,
“Help”);
new NotCondition(
new PropertyCondition(
AutomationElement.ControlTypeProperty,

ControlType.Button ) ) );

Regarding a property condition, the following code snippet indicates a requested filter based on the invoke command:
Condition invokeCond=new PropertyCondition (AutomationElement.IsInvokePatternAvailableProperty, TRUE).

Table 4 illustrates exemplary code to create a tree-walker component that navigates a view defined by a condition. The condition can be passed to the tree walker's constructor:

TABLE 4
Exemplary pseudocode to navigate
the view defined by a condition

Condition condition = ...;
TreeWalker customWalker = new TreeWalker( condition );
// Gets the first child of el, under the view specified by the
above condition
AutomationElement child = customWalker.GetFirstChild( el );

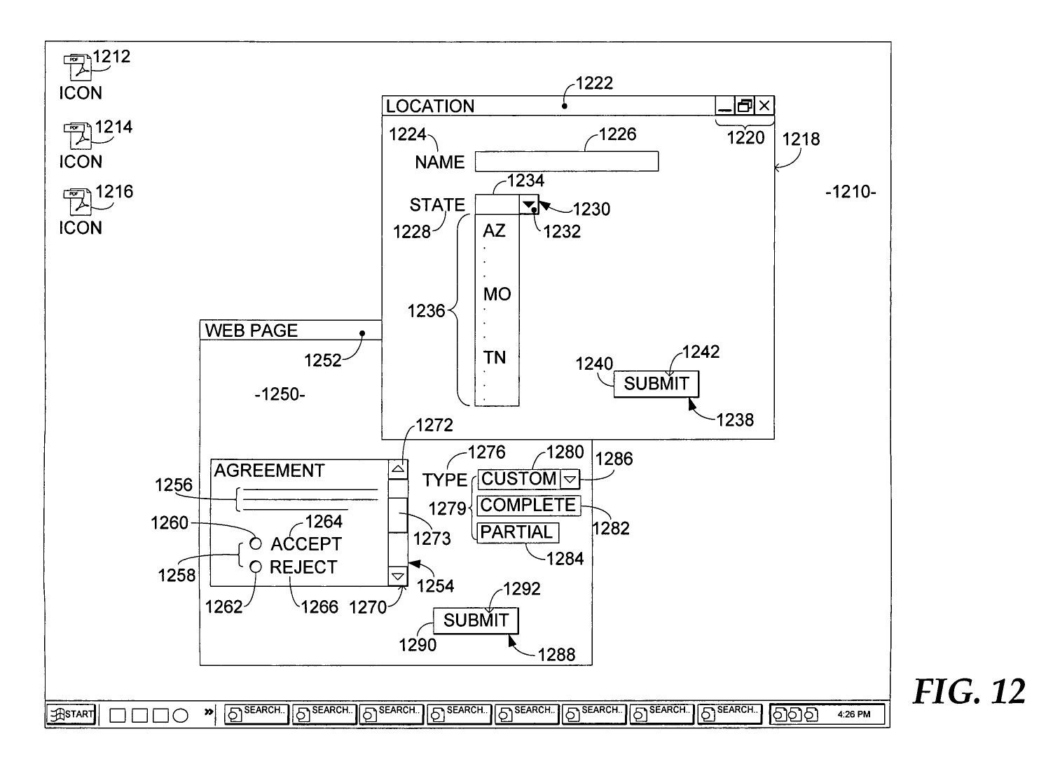

Turning now to FIG. 12, an embodiment of the present invention will be explained in still greater detail with reference to the illustrative target component 1210. Target component 1210 represents a desktop, and includes a first icon 1212, a second icon 1214, and a third icon 1216. Still further, a first window 1218 is shown. First window 1218 includes a set of sizing buttons 1220 as well as a title bar 1222. First window 1218 will be referred to as a location window for the sake of clarity. Location window 1218 includes a name label 1224 as well as a name textbox 1226. A state label 1228 is associated with a state drop-down box 1230, which is composed of a rectangle 1234, a drop-down button 1232, and a list of states 1236. Exemplary states shown are “AZ,” “MO,” and “TN.” Location window 1218 also includes a submit button 1238, which is composed of a rectangle 1240 as well as a label 1242.

A second window, a Web page, is referenced generally by the numeral 1250. Web page 1250 includes a title bar 1252 as well as a list box 1254. For illustrative purposes, list box 1254 represents an agreement that a user may need to acquiesce to use a software product. Textbox 1254 includes a set of text lines 1256 as well as a radio-button grouping 1258, which includes an accept option 1260 and a reject option 1262. An accept label 1264 is included along with a reject label 1266 corresponding to their respective options. A scrollbar 1270 is depicted as including an up button 1272, a slider 1273, and a down button 1274. Web page 1250 also includes a drop-down box 1279, which is composed of first, second, and third entries (1280, 1282, and 1284) as well as a drop-down button 1286. Finally, a submit button 1288 is shown as being composed of a rectangle 1290 and a submit label 1292.

Note that not all elements associated with target component 1210 are numbered. Many other elements could also be labeled, but are not for the sake of simplicity and so as not to obscure the present invention.

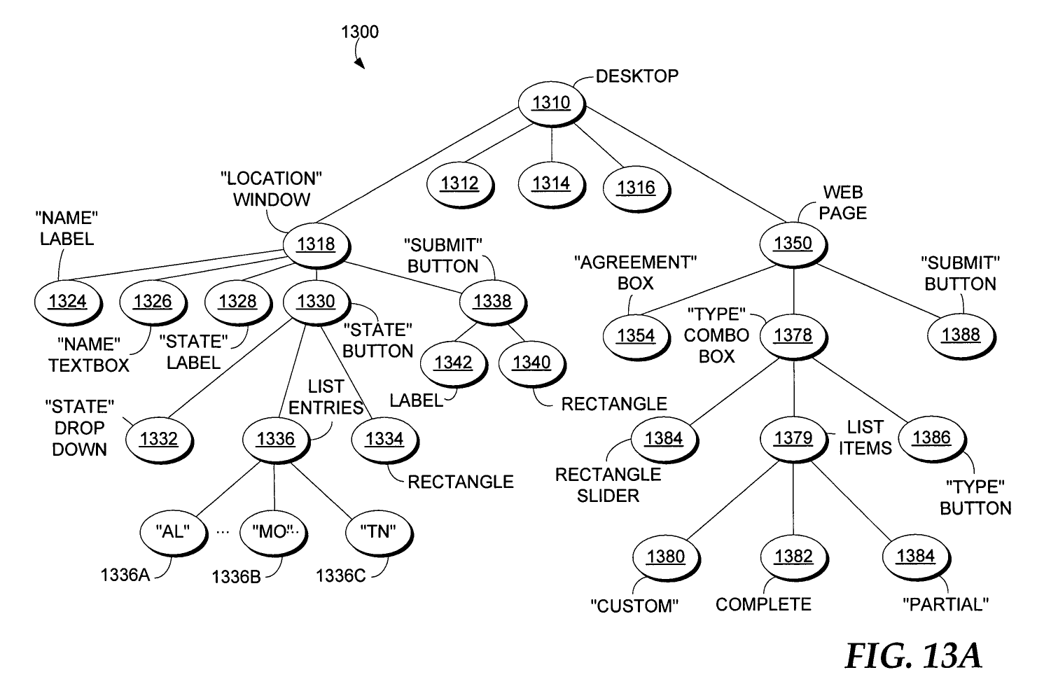

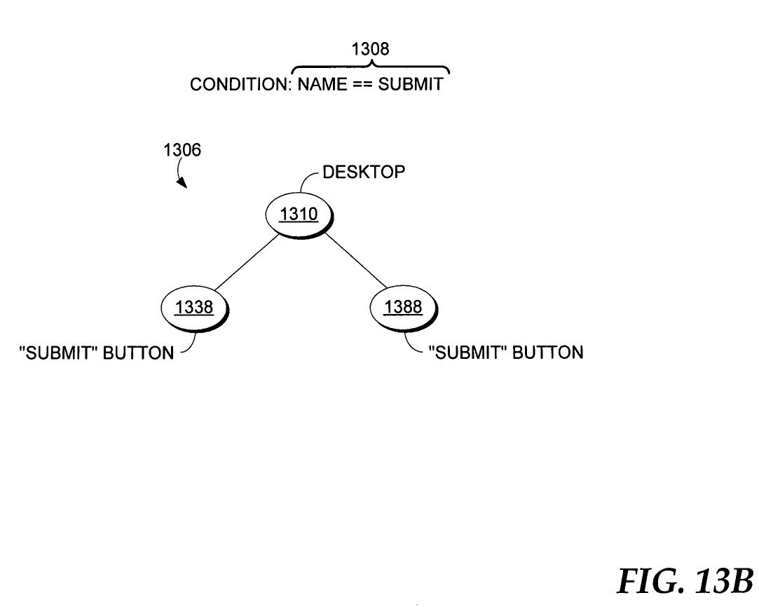

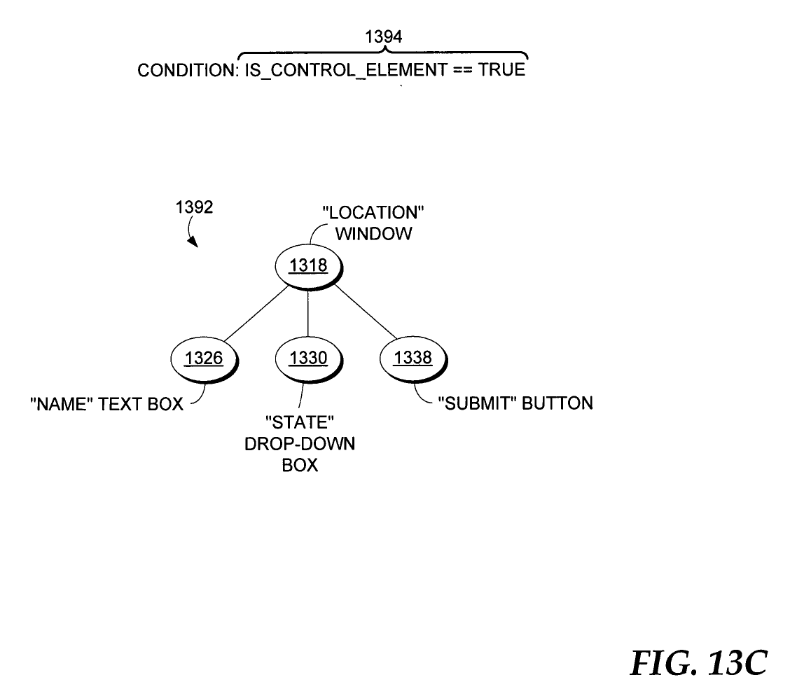

Turning now to FIG. 13A, wherein like reference numerals correspond to like reference numerals of FIG. 12, a raw tree 1300 represents the various UI elements of FIG. 12 according to an embodiment of the present invention. As shown, raw tree 1300 is composed of elements from various platforms (location window 1318, Web page 1350, etc.). Even though the platforms associated with location window 1318 and Web page 1350 may have incompatible APIs, a requesting component, such as requesting component 1012, would be presented with a first level of simplicity in only having to interface with a single unified tree, namely raw tree 1300.

As mentioned, the numerals of FIG. 13A line up with the numerals of FIG. 12. For example, desktop 1310 in FIG. 13A is denoted as numeral 1210 in FIG. 12. The desktop is represented as having several children, including location window 1318, icons 1312-1316, and Web page 1350. Location window 1318 is shown as having various child elements that correspond to UI elements of location window 1218. Note that node 1330, which represents “state” button 1230, is depicted as having three children, including the drop-down box 1332, the list of entries 1336, and a rectangle 1334. Note further that the list entries of node 1336 are specifically represented as further child nodes, 1336A, 1336B and 1336C.

Now assume that requesting component 1012 is concerned with all elements named “submit.” Turning to FIG. 13B, a condition 1308 is provided indicating that elements that have an attribute where their name is “submit” is provided. The only elements of raw tree 1300 that satisfy condition 1308 are the nodes associated with submit button 1338 and 1388. Accordingly, filtered tree 1306 is what would be represented to requesting component 1012 rather than raw tree 1300. If requesting component 1012 requested the first and last child of desktop node 1310 with the condition that the element be named “submit,” then requesting component 1012 would be presented with tree 1306.

Turning now to FIG. 13C, another filtered tree 1392 is depicted and representative of what would be presented to requesting component 1012 subject to a condition 1394, which requests only elements of location window 1218 that are control elements, such as buttons. The root node, 1318, is preferably always provided. Other exemplary nodes that would be shown would be those that can be clicked on in their own right, for example nodes 1326, 1330, and 1338, which respectively correspond to the “name” textbox, the “state” drop-down box, and the “submit” button. Other control elements, such as individual items of a list box may also be included in tree 1392. Navigating tree 1392 would be substantially easier than navigating raw tree 1300.

We will now provide and explain first an illustrative structure of an API to facilitate functionally described above and second an illustrative pseudocode and examples describing in greater detail how the present invention provides such functionality.

Turning first to Table 5, illustrative pseudocode is provided that highlights exemplary embodiments of programmatic representations of automation element 1024, tree walker 1022, and other components. The pseudocode depicted in Table 5, as well as anywhere in this disclosure, is illustrative in nature and should not be construed as a limitation of the present invention. If a skilled artisan were to quip, he or she would note that the API structure of Table 5 is but one of many ways to skin a cat, that is, to provide the functionality described herein.

TABLE 5
Exemplary API Structure

class AutomationElement
{

// Same set of properties/events/methods as former
LogicalElement, except:
// Parent/FirstChild/LastChild/NextSibling/PreviousSibling
removed
...

}
class Automation
{

...
// Predefined conditions for Raw and Control views
public static readonly Condition RawViewCondition = ...;
public static readonly Condition ControlViewCondition = ...;

}
class TreeWalker
{

public TreeWalker( Condition condition );
// Navigation methods that do not prefetch
public AutomationElement GetParent( AutomationElement
element );
public AutomationElement GetFirstChild( AutomationElement
element );
public AutomationElement GetLastChild( AutomationElement
element );
public AutomationElement GetNextSibling(
AutomationElement element );
public AutomationElement GetPreviousSibling(
AutomationElement element );
public AutomationElement Normalize( AutomationElement
element );
// Navigation methods that prefetch - see AutomationElement
Prefetch spec
public AutomationElement GetParent ( AutomationElement
element, CacheRequest

request );

public AutomationElement GetFirstChild( AutomationElement
element,

CacheRequest request );

public AutomationElement GetLastChild( AutomationElement
element,

CacheRequest request );

public AutomationElement GetNextSibling( AutomationElement
element,

CacheRequest request );

public AutomationElement GetPreviousSibling(
AutomationElement element,

CacheRequest request );

public AutomationElement Normalize( AutomationElement
element,
CacheRequest

request );

// Predefined walkers for Raw and Control views
public static TreeWalker RawViewWalker = ...;
public static TreeWalker ControlViewWalker = ...;

}
class CacheRequest
{

// See AutomationElement Prefetch spec for other
properties/methods
...
Condition TreeFilter { get; set; }

}
//
// Conditions - Used to define custom views
class PropertyCondition
{

PropertyCondition( AutomationProperty property, object val );
AutomationProperty Property { get; }
object Value { get; }

}
class AndCondition
{

AndCondition( params Condition [ ] conditions );
Condition [ ] GetConditions( );

}
class OrCondition
{

OrCondition( params Condition [ ] conditions );
Condition [ ] GetConditions( );

}
class NotCondition
{

NotCondition( Condition condition );
Condition { get; }

}

Working through the pseudocode of Table 5, an instantiation of the automation element class is provided, which can be automation element 1024 in some embodiments. Automation element 1024 is the mechanism used by the API of Table 5 to expose a node, which can be a piece of UI (button, list, window, rectangle, text, button, image, etc). Automation element includes methods to allow access to properties 320C (such as “get properties,” is focused, is focusable . . . ).

The Automation class can be used to refer to predefined views, such as a “control” view.

An instantiation of the TreeWalker class is provided, which can be tree walker 1022 in some embodiments. Tree walker 1022 preferably includes methods that facilitate tree navigation in a specified direction. It accepts one or more conditions as shown, and then uses the methods shown (GetParent, GetFirstChild, etc.) to evaluate the condition against various UI elements.

Exemplary conditions are also provided. A property condition, and several Boolean conditions are shown to illustrate various standards or requirements to be satisfied by UI elements.

We will now discuss in greater detail how the present invention provides the various aspects of the aforementioned functionality. Given an underlying raw tree (such as raw tree 1300 for example), primitives for navigating over it (Parent, FirstChild, NextSibling), and one or more conditions that indicate whether a given node should appear in a desired view of the tree, operations can be constructed to return the corresponding nodes on the filtered view of the tree.

Three operations are elaborated on here because they are illustrative of other functional aspects described herein. The purely illustrative names of these operations used herein for referential purposes will be GetViewParent, GetViewFirstChild, and GetViewNextSibling. These operations can use any node as a starting point, and will traverse the portions of the tree necessary to find the result. Three internal helper methods: TryAsParent, TryAsFirstOrNext, and TryContinuedNext are also respectively included. No state needs to be maintained between calls to these operations.

In a preferred embodiment, an API is provided that includes code that effects the pseudocode depicted in the Table 6. In a preferred embodiment, the code is tail recursive—recursive calls would have no code following then in the calling function. Such a scheme enables the technology to be embodied differently and converted to other implementations, such as an iteration-and-table-based finite state machine.

Turning to Table 6, a portion of the API relating to GetViewParent is provided.

TABLE 6
Exemplary pseudocode of an embodiment of GetViewParent,
GetViewFirstChild, GetViewNextSibling

// Make the initial step in the direction of the parent...
Node GetViewParent( Node node )
{

Node tentative = Parent( node );
if( tentative != NULL )

return TryAsParent( tentative );

return NULL;

}
// keep walking upwards till one of the parents satisfies the
condition...
Node TryAsParent( Node node )
{

if( SatisfiesCondition( node ) )

return node;

Node tentative = Parent( node );
if( tentative != NULL )

return TryAsParent( tentative );

return NULL;

}
// Make the initial step in the direction of first child...
Node GetViewFirstChild( Node node )
{

Node tentative = FirstChild( node );
if( tentative != NULL )

return TryAsFirstOrNext( tentative );

return NULL;

}
// Keep walking down through nodes till we find one that
satisfies the
condition...
Node TryAsFirstOrNext( Node node )
{

if( SatisfiesCondition( node ) )

return node;

Node tentative = FirstChild( node );
if( tentative != NULL )

return TryAsFirstOrNext( tentative );

// If we hit the bottom, need to instead look sidewards for
a node that

satisfies

// the condition...
return TryContinuedNext( node );

}
// Make initial step in direction of next sibling...
Node GetViewNextSibling( Node node )
{

Node tentative = NextSibling( node );
if( tentative != NULL )

return TryAsFirstOrNext( tentative );

// If no next sibling, check for a parent
Node parent = Parent( node );
if( parent = = NULL )

return NULL;

// If parent satisfies condition, then it really is a parent
node in the view
// of the tree,
// so there's no sibling to be found
if( SatisfiesCondition( parent ) )

return NULL;

// Otherwise, step up and through the parent to look for a
potential next

sibling

return TryContinuedNext( parent );

}
// Step through this node - forwards, then upwards, looking for
a next sibling or
first
// child that satisfies the condition
Node TryContinuedNext( node )
{

Node tentative = NextSibling( node );
if( tentative != NULL )

return TryAsFirstOrNext( node );

Node parent = Parent( node );
if( parent = = NULL )

return NULL;

if( SatisfiesCondition( parent ) )

return NULL;

return TryContinuedNext( parent );

}

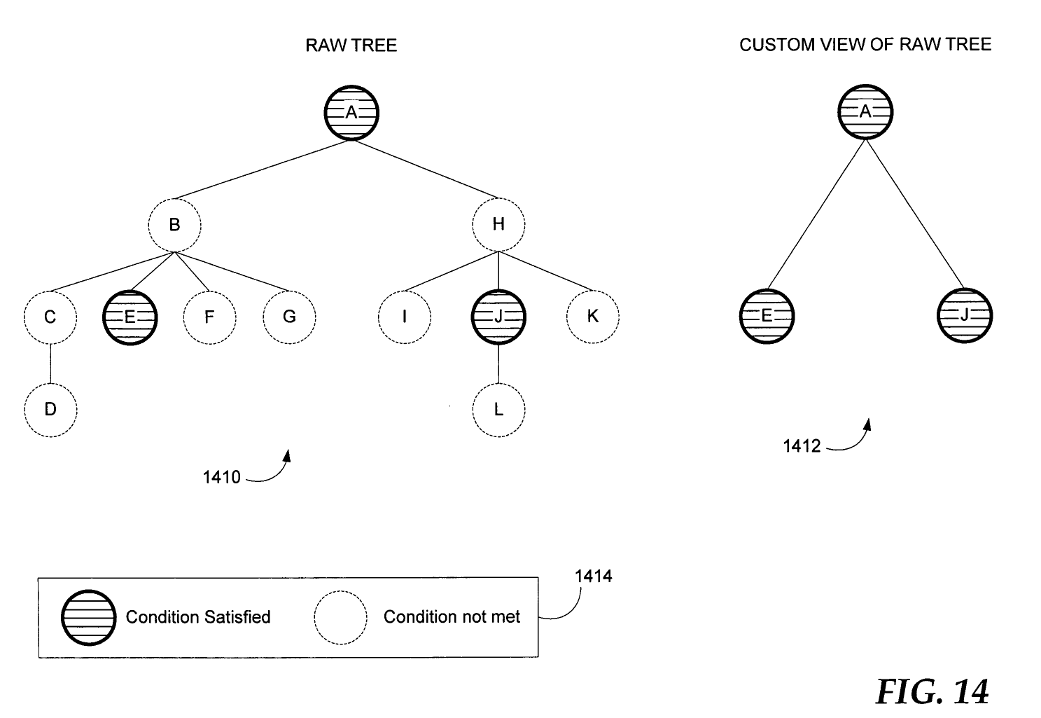

An illustrative example of implementing the pseudocode of Table 6 as it relates to GetViewParent is provided with reference to FIG. 14 to pass information related to the parent of the UI element associated with node E. The steps followed are illustrated in Table 7 below.

TABLE 7
Determination of Node E's conditional parent (See FIG. 14)

| Action | Result |
|---|---|
| GetViewParent( E ): | Parent( E ) is B, call TryAsParent( B ) |
| TryAsParent( B ): | Condition( B ) fails. Parent( B ) is A, call |
| | TryAsParent( A ) |
| TryAsParent( A ): | Condition( A ) succeeds, RETURN A |

Starting node E is received. The parent of node E in raw tree 1410 is determined to be node B. The TryAsParent method (Table 6) is called on node B of raw tree 1410. Whatever condition 1032 (FIG. 10) was provided to create custom tree 1412 is evaluated against node B. Node B does not satisfy the condition. Thus, node B's parent is sought and identified as node A. The provided condition 1032 is evaluated against node A, which succeeds. Thus, node A is returned to the applicable requesting component 1012.

An illustrative example of implementing the pseudocode of Table 6 as it relates to GetViewFirstChild is provided with further reference to FIG. 14 to provide information related to the first child of node A of raw tree 1410. The steps followed are illustrated in Table 8 below.

TABLE 8
Determination of Node A's conditional first child - (See FIG. 14)

| Action | Result |
|---|---|
| GetViewFirstChild( A ): | FirstChild( A ) is B, call |
| | TryAsFirstOrNext ( B ) |
| TryAsFirstOrNext( B ): | Condition( B ) fails. FirstChild( B ) |
| | is C, call TryAsFirstOrNext( C ) |
| TryAsFirstOfNext( C ): | Condition( C ) fails. FirstChild( C ) |
| | is D, call TryAsFirstOrNext( D ) |
| TryAsFirstOfNext( D ): | Condition( D ) fails. FirstChild( D ) |
| | is NULL. Call TryContinuedNext( D ) |
| TryContinuedNext( D ): | NextSibling( D ) is NULL. Parent( D ) |
| | is C, Condition( C ) fails, call |
| | TryContinuedNext( C ) |
| TryContinuedNext( C ): | NextSibling( C ) is E, call |
| | TryAsFirstOrNext( E ) |
| TryAsFirstOrNext( E ): | Condition( E ) succeeds, RETURN E |

Calling FirstChild on node A returns node B. Condition 1032 is evaluated against node B by calling TryAsFirstOrNext and passing an identifier that identifies node B. The condition fails, as indicated by legend 1414. Next in this embodiment, the FirstChild of node B is determined to be node C of raw tree 1410. Method TryAsFirstOrNext is called on node C.

Node C of raw tree 1410 does not meet condition 1032. Continuing to progressively identify children of nodes that do not meet condition 1032, the FirstChild method called on node C to identify node D. Having identified node D, the TryAsFirstOrNext method is called on node D in a preferred embodiment.

Node D of raw tree 1410 also does not meet condition 1032. But now, the FirstChild method on node D returns NULL. Accordingly, the TryContinuedNext method is called on node D. By way of executing method TryContinuedNext on node D, NextSibling (D) returns NULL. Having hit an isolated node (node D), its parent is identified by invoking the Parent method on node D, which returns C. The Parent method is invoked, rather than merely recalling node D as C's parent, because raw tree 1410 is dynamic, and possibly may have changed. This is also why condition 1032 is (re)evaluated against node C. Node C does not meet condition 1032. Thus, the TryContinuedNext method is called on node C.

Calling TryContinuedNext on node C reveals that the next sibling of node C is node E. Thus, TryAsFirstOrNext (E) causes condition 1032 to be evaluated against node E. With the condition being satisfied, node E is returned to requesting component 1012. To “return node E” is to return information associated with the UI element that node E represents; information such as links 320A, properties 320B, patterns 320C, and events 320D.

Following the format above, Table 9 provides illustrative steps consistent with the API of Table 6 to provide to a requesting component with information related to the piece of UI represented by node E's next sibling subject to a condition according to an embodiment of the present invention. Table 9 should be read with reference to FIG. 14.

TABLE 9
Determination of Node E's conditional next sibling (See FIG. 14)

| Action | Result |
|---|---|
| GetViewNextSibling(E): | NextSibling( E ) is F, call |
| | TryAsFirstOrNext( F ) |
| TryAsFirstOrNext( F ): | Condition( F ) fails. FirstChild( F ) is NULL. |
| | Call TryContinuedNext( F ) |
| TryContinuedNext( F ): | NextSibling( F ) is G, call |
| | TryAsFirstOrNext( G ) |
| TryAsFirstOrNext( G ): | Condition( G ) fails. FirstChild( G ) is NULL. |
| | Call TryContinuedNext(G) |
| TryContinuedNext( G ): | NextSibling( G ) is NULL. Parent( G ) is B, |
| | Condition( B ) fails, call |
| | TryContinuedNext( B ) |
| TryContinuedNext( B ): | NextSibling( B ) is H, call |
| | TryAsFirstOrNext( H ) |
| TryAsFirstOrNext( H ): | Condition(H) fails. FirstChild( H ) is I, |
| | call TryAsFirstOrNext( I ) |
| TryAsFirstOrNext( I ): | Condition( I ) fails. FirstChild( I ) is NULL. |
| | Call TryContinuedNext( I ) |
| TryContinuedNext( I ): | NextSibling( I ) is J, call |
| | TryAsFirstOrNext( J ) |
| TryAsFirstOrNext( J ): | Condition( J ) succeeds, RETURN J. |

Following the format above, Table 10 provides illustrative steps consistent with the API of Table 6 to provide to a requesting component with information related to the piece of UI represented by node J's next sibling subject to a condition according to an embodiment of the present invention. Table 10 should be read with reference to FIG. 14.

TABLE 10
Determination of Node J's conditional next sibling (See FIG. 14)

| Action | Result |
|---|---|
| GetViewNextSibling( J ): | NextSibling( J ) is L, call |
| | TryAsFirstOrNext( L ). |
| TryAsFirstOrNext( L ): | Condition fails. FirstChild( L ) is NULL. |
| | Call TryContinuedNext( L ). |
| TryContinuedNext( L ): | NextSibling( L ) is NULL. Parent( L ) is H, |
| | Condition fails, call TryContinuedNext( H ). |
| TryContinuedNext( H ): | NextSibling( H ) is NULL. Parent( H ) is A, |
| | Condition( A ) succeeds, RETURN NULL |

A final illustration is provided with respect to Table 11, which provides illustrative steps consistent with the API of Table 6 to provide to a requesting component with information related to the piece of UI represented by node J's first child subject to a condition according to an embodiment of the present invention. Table 11 should be read with reference to FIG. 14.

TABLE 11
Determination of Node J's conditional first child (See FIG. 14)

| Action | Result |
|---|---|
| GetViewFirstChild( J ): | FirstChild( J ) is K, call |
| | TryAsFirstOrNext( K ). |
| TryAsFirstOrNext( K ): | Condition fails. FirstChild( K ) is NULL. |
| | Call TryContinuedNext( K ). |
| TryContinuedNext( K ): | NextSibling( K ) is NULL. Parent( K ) is J, |
| | Condition( J ) succeeds, return NULL. |

Employing Prefetching

The process that contains the target UI may be entered into to enable capturing of node structure and information, serializing of the results, returning them to requesting component 1012, and then reconstruction of the structure based on the captured information on the client side. The caller can then work against this reconstructed captured snapshot instead of having to make expensive cross-process calls to visit the UI elements in the other processes.

The present invention traverses a raw tree using a depth-first traversal, serializing as it does so, and omits information about any nodes that do not satisfy the condition(s) 1032. The serialized data returned includes a table of properties, with as many rows as elements that matched the condition, and as many columns as properties that were requested; and a string that indicates the structure of the filtered tree.

The structure of the is produced by preferably performing a depth-first traversal of the tree, and adding a first marker when arriving at a node, and adding a different marker when leaving a node (after having visited all the node's children in this embodiment). Although any character or string may be used, an open parentheses ‘(’ is used herein as an exemplary entry marker, and a closed parentheses ‘)’ is used to denote an exemplary the exit marker. For example, a tree with one root node containing two child nodes could be represented as: “(( )( ))”.

This is somewhat akin to the representation of tree structures used by the programming languages Lisp and Scheme. The lack of recording markers for nodes that do not satisfy the condition is enough to remove them from the tree that the client sees.

Pseudo-code that illustrates such a traversal is depicted below in Table 12.

TABLE 12
Exemplary pseudocode generating custom views using prefetching

// Structure and properties are ‘in/out’ objects that are passed
by reference
// so they can be appended to.
CollectSubtree( Node root, string structure, table properties )
{

// If this node is in the view, add an entry marker, and add
a row to the
// table containing its properties
bool satisfiedCondition = false;
if( SatisfiesCondition( root ) )
{

satisfiedCondition = true;
structure.Append(′(′ );
table.AppendRow( GetProperties( root ) );

}
// Recursively process children
for( Node child = FirstChild( root ) ; child != NULL ; child =
NextSibling(

child ) )

{

CollectSubtree( child, structure, properties );

}
// Add an exit marker, but only if we added an entry marker...
if(satisfiedCondition )
{

Structure.Append(′)′ );

}

}

Exemplary pseudocode for parsing the string is depicted below in Table 13.

TABLE 13
Exemplary pseudocode for parsing a string
generated by the pseudocode of Table 12

// Initial call should use index = 0
// This version assumes a well-formatted string
Node ParseString( String str, int index )
{

if( str.Length >= index || str[ index ] != ′(′ )

return NULL;

index = index + 1;
Node = new Node( );
while(true)
{

Node child = ParseString( str, index );
if( child = = NULL )

break;

node.AddChild( child );

}
index++; // Skip over closing ′)′.
return node;

}

In a preferred embodiment, the present invention also checks for errors in the string, and, for each node constructed, attaches information from the next successive row in the table of properties from the matching elements. An exemplary run is depicted in Table 14 below, with reference to FIG. 14.

TABLE 14
Illustrative example of employing the pseudocode
of in Table 12 on the tree of FIG. 14

Visited Appended to string
Enter A Add ‘(‘

Enter B

Enter C

Enter D
Leave D

| | |
|---|---|
| Enter E | Add ‘(‘ |
| Leave E | Add ‘)’ |
| Enter F | |
| Leave F | |
| Enter G | |
| Leave G | |

Leave B
Enter H

| Enter I | |
|---|---|
| Leave I | |
| Enter J | Add ‘(‘ |

Enter K
Leave K

| | |
|---|---|
| Leave J | Add ‘)’ |
| Enter L | |
| Leave L | |

Leave H

Leave A Add ‘)’

When run against the tree 1410, it is traversed depth-first, resulting in the node being visited and the string is build up as follows shown. This results in the string “(( )( ))”, which, when deserialized by the caller, results in subtree 1412—consisting of a root containing two nodes, each of which contains no children—which is the desired filtered view.

Integrated Query Support (Additional Prefetching)

The present invention reduces the number of times process boundaries need to be crossed in connection with retrieving information about elements of a target UI. Table 15 provides two exemplary snippets of pseudocode that illustrate an inefficient and expensive process of obtaining UI element information. In this example, the code is employed to retrieve the “name” property and bounding “rectangle” property of a target element.

TABLE 15
Exemplary pseudocode of an inefficient and expensive
process of obtaining UI element information:

AutomationElement el = AutomationElement.FocusedElement;
string name=(string)
el.GetCurrentPropertyValue(AutomationElement.NameProperty);
Rect rect=(Rect)
el.GetCurrentValue(AutomationElement.BoundingRectangleProperty);

OR

string name = el.Current.Name;
Rect rect = el.Current.BoundingRectangle;

As shown in Table 15, an API may be called with instructions to retrieve the current properties, or (with reference to the second code fragment) an explicit method may not even be called. But both approaches will most likely result in making at least two cross-process calls: one to retrieve the name property of a target object, and another to retrieve information related to a corresponding bounding rectangle. If four, five, or tens of properties needed to be retrieved, multiple cross-process calls could ultimately result in the requesting application appearing to be nonresponsive, bogged down by the expensive cross-process calls. The inefficiencies of employing technologies such as those of Table 15 are amplified not only by the number of properties that need to be retrieved for a given element, but also by the number of elements themselves. The present invention substantially reduces such inefficiencies.

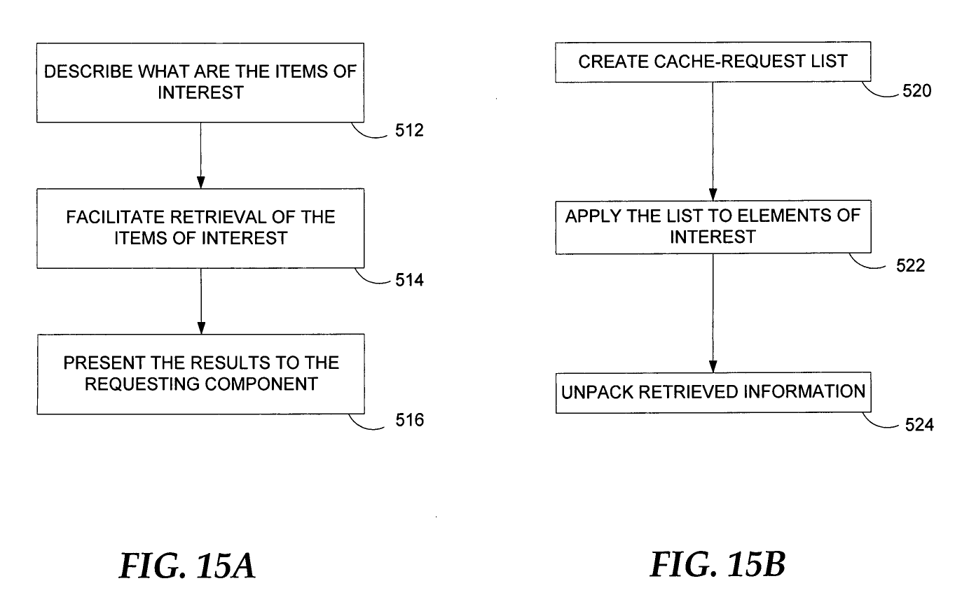

Turning now to FIG. 15A, a flow diagram is provided that illustrates a method for obtaining UI element information according to an embodiment of the present invention. The steps do not need to occur in the order shown. At a step 512, items of interest are described, and often, the items of interest are UI elements. A client application will desire to retrieve information about a UI. As will be explained in greater detail below, one way to provide a description of items of interest is to employ a CacheRequest, which is a list of attributes to receive.

At a step 514, the present invention facilitates the retrieval of items of interest. The present invention retrieves the elements (including structure relating to the elements) and contemporaneously retrieves specified attributes related to those elements. Thus, when the elements are returned, so too are the attributes requested, thereby eliminating the need to make subsequent cross-process calls to retrieve the attribute information.

At a step 516, the bundled results are presented to the requesting component. Thus, a set of UI elements can be created from returned data, which includes information about the structure of and relationship between elements (tree) and properties related to those elements. In one embodiment, the UI Elements themselves remain where they are in the other process—what gets created in the client process is a structure that represents those remote UI Elements. In other embodiments, events can trigger the automatic pushing of data and attributes to a client application without it having to request the data.

FIG. 15B is a flow diagram that depicts an alternative embodiment, wherein a cache-request list is created at a step 520 so that the conditions specified in the list can be applied against the elements of interest in step 522. Attribute information is bundled with the elements that were the result of the query and then unpacked at a step 524.

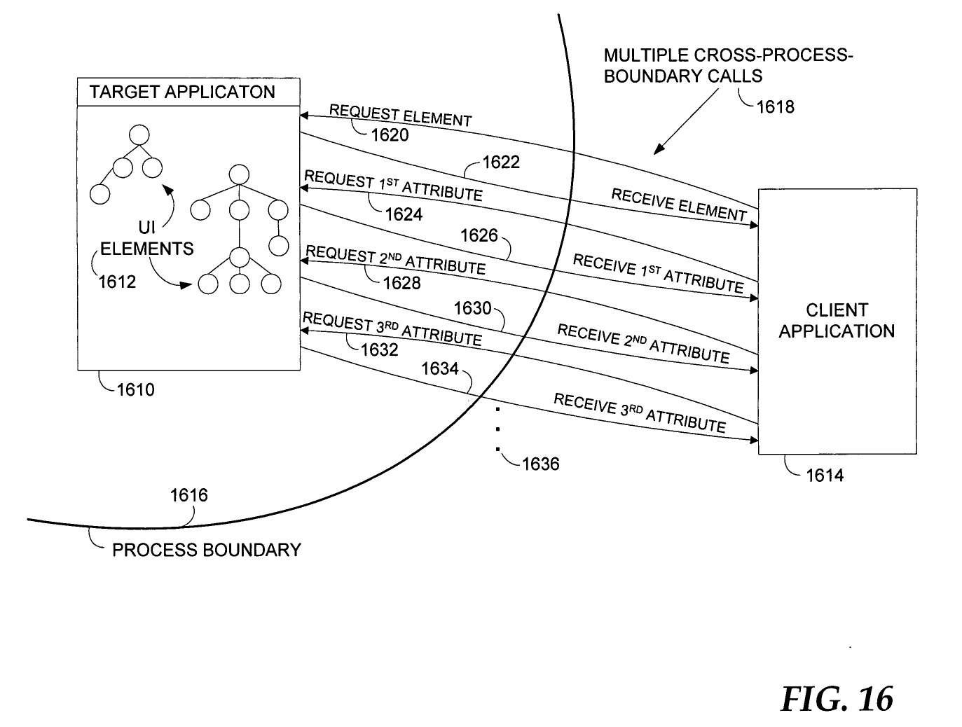

Turning now to FIG. 16, a block diagram depicts an exemplary current, inefficient method for gathering information about a UI and its corresponding elements. A target application 1610 includes a set of UI elements represented according to an embodiment of the present invention as tree structures 1612. A client application 1614 is separated from target application 1610 by process boundary 1616. Process boundary 1616 is not a physically boundary, but illustratively represents a demarcation indicator separating two processes; which are target application 1610 and client application 1614 in this example. Client application 1614 may be an assistive-technology application for example, such as a screen reader, command follower, magnifier, or other programs recited herein or known in the art.

As used herein, a “cross-process” call refers to a call that reaches across process boundaries. For example, a first process may be a client process (such an assistive-technology application like a screen reader, magnifier, speech application, etc.) and the other process may be any other application, such as a word-processing application, spreadsheet application, Web browser, e-mail application, game, etc. For the client to communicate with the other application, it needs to synchronize across one or more process boundaries. Moreover, our use of the term “cross-process call” includes overhead for both the call and return portion. While there are some similar and some different costs associated with setting up the call and then receiving the result, we treat the whole as a single operation. While in some contexts the term “call” is implied to be synchronous (e.g., it waits for the result) and includes a return value (e.g., to C and other high-level language developers), in other contexts (e.g., low-level networking), calls can sometimes be one-way or asynchronous, and don't include a “return” phase.

With continuing reference to FIG. 16, multiple cross-process-boundary calls (referenced generally by the numeral 1618) are required to gather information about one or more UI elements. For example, client application 1614 may first submit a request 1620 for a desired element. The element will be received at a step 1622. Then client application 1614 may submit a first request 1624 for a first attribute, which is received at a step 1626. Further, client application 1614 may then submit a second request 1628 for a second attribute, which is received at a step 1630. This process may continue a third time (1632 and 1634), as well as fourth, fifth, etc., as shown by ellipses 1636. All of these cross-process calls 1618 are resource expensive, and negatively affect the performance of client application 1614 among other things.

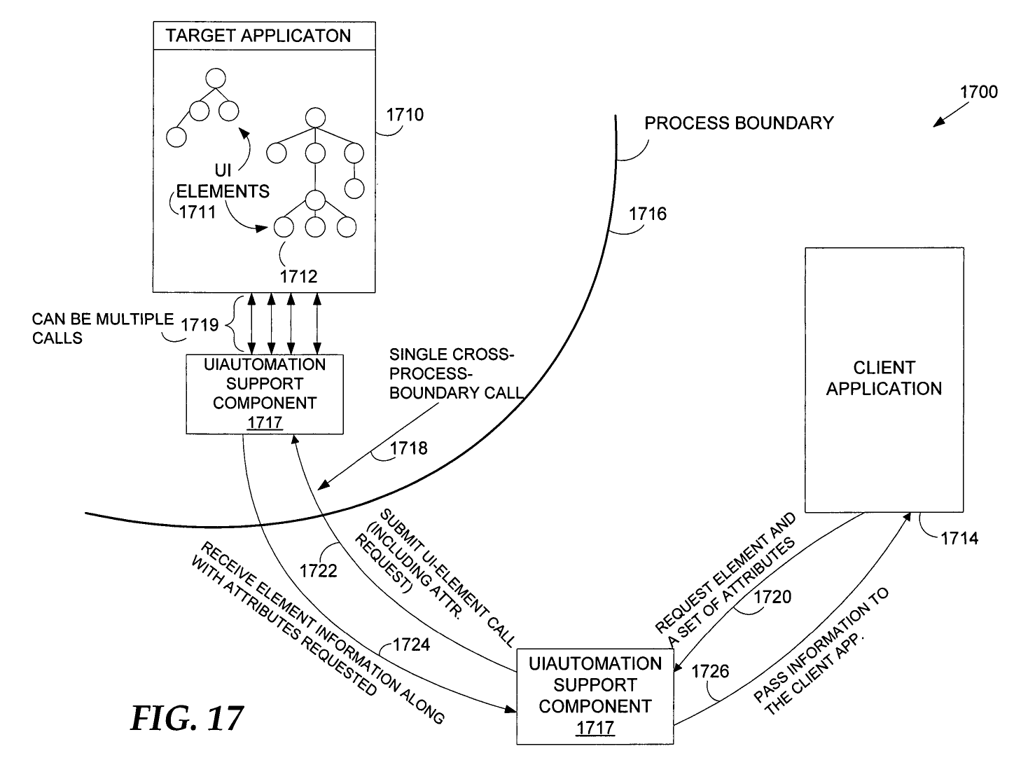

Rather than serially crossing process boundaries to iteratively gather information about UI elements, a mechanism is provided according to an embodiment of the present invention to identify items of interest, to specify desired informational attributes of target components. This mechanism can take on many forms, such as a programmatic list, or cache request, in a preferred embodiment. A mechanism is also provided to facilitate information retrieval (wherein expensive cross-process-boundary calls are minimized), and to make the retrieved information available to a requesting component; that is, to expose the information to a requesting component, such as the client application of FIG. 17.

Turning now to FIG. 17, a block diagram is provided that depicts an exemplary operating environment according to an embodiment of the present invention and is referenced generally by the numeral 1700. Operative environment 1700 includes a target application 1710, which includes one or more user interfaces and elements, represented according to an embodiment of the present invention at trees 1712. Target application 1710 is separated from a client application 1714 (which, as previously mentioned, can be an assistive-technology or other application) by a process boundary 1716. Process boundary 1716 can be the same as process boundary 1616. In the same process as client application 1714 is a UIAutomation support component 1717, which provides the functionality of prefetching attributes associated with elements of interest, which will be explained in greater detail below. Similarly, another instance of UIAutomation support component 1717 is present on the same process boundary as target application 1710.

In the embodiment shown, only a single cross-process-boundary call 1718 needs to be made, instead of the multiple cross-process calls 1618 depicted in FIG. 16. The provider-side API instance 1717 facilitates multiple calls 1719 to the actual provider 1710, and then returns an aggregated result. Many pieces of information may be retrieved at step 1719, but all the calls are done in-process according to one embodiment of the present invention.

Summarily, client application 1714 requests one or more elements and a set of attributes respectively corresponding to the element(s) at a step 1720. A first instance of UIAutomation support component 1717 submits a call to a second instance of UIAutomation support component 1717, which is in communication with target application 1710 (and thereby can submit multiple calls to target application 1710, but not cross-process calls). The call describes the element(s) of interest as well as a set of corresponding attributes. The attributes and other information are gathered, aggregated, and then communicated between instances of UIAutomation support component 1717 at a step 1724, wherein it is passed to client application 1714 at a step 1726. The processes will now be described in greater detail.

With reference to Table 16, illustrative pseudocode is provided that enables the retrieval of properties and/or patterns from an element, such as Automation Element 1024. A CacheRequest object is employed to specify properties of interest. Table 16 contemplates a user who wants to work with Name and InvokePattern, for example.

TABLE 16
Exemplary pseudocode for building a CacheRequest list

CacheRequest creq = new CacheRequest( );
CacheRequest.Add( AutomationElement.NameProperty );
CacheRequest.Add( AutomationElement.BoundingRectangleProperty );
CacheRequest.Add( InvokePattern.Pattern );

The CacheRequest is similar to a mathematical set—adding any property or pattern more than once is preferably a silent no-op. The process that is being described is also somewhat akin to a database-query scheme, except that database queries cannot account for structure, such as the tree structures that have been described throughout this disclosure. The Cache-Request list is built up so that it can be applied against an external collection of data (such as trees 1712) to retrieve a desired result, all the while accounting for the unique aspects associated with gathering information from elements arranged in a hierarchal tree-like and user-interface structure. These concepts do not apply in database systems.

The CacheRequest class of Table 16 illustrates a means whereby a list of items as well as corresponding attributes, such as patterns and properties, can be provided according to one embodiment of the present invention. An instance of the CacheRequest class is created, and then methods are called that add to the list. As shown, the following properties are added: “name,” “rectangle,” and a component that allows the requesting application to access the “invoke” (or equivalent) functionality or the corresponding UI element. Thus, if the UI element of interest was a button, then “invoke” functionality is that which provides the mechanism to click the button.

With continuing reference to FIG. 15A, the Cache-Request list is applied to elements of interest. As depicted in Table 17, a user can activate a CacheRequest either by using Push( )/Pop( ) (or their equivalents), or by using Activate( ) within a Using( ) block in an embodiment. Although methods recited herein such as “Activate( )” and “Using( )” may be syntactically associated with certain programming languages (such as C#), those skilled in the art will appreciate that alternative methods or functions could also be used in connection with other programming languages that offer similar functionality. All new Automation Elements obtained while a CacheRequest is active will preferably have the specified properties and patterns prefetched.

TABLE 17
Exemplary pseudocode of applying a Cache-Request
list to elements of interest

AutomationElement el;
using( creq.Activate( ) )
{

el = AutomationElement.FocusedElement;

}

An “activate” method is employed on the CacheRequest so that all new elements returned within the scope of the “using( )” block should have the requested list of properties prefetched and bundled with them. This scheme is a significant improvement over other technologies, and in the world of computer processing, is somewhat akin to the increased efficiency that is accorded to an individual who goes to a grocery store once with a list and retrieves all items of interest instead of being constrained to retrieving only a single item per grocery-store visit.

With reference to Table 17, instead of merely receiving back the item that currently has the focus (in this example), properties associated with that item will be prefetched and returned with the item (see also steps 1724 and 1726 of FIG. 17). In this embodiment, those properties are referenced by and exposed to client application 1714 by the “using( creq.Activate” line, where “creq” refers to an instance of the CacheRequest, which delineates the attributes of interest to be returned in connection with a given item. According to an embodiment of the present invention, that which gets returned is not just the element but rather is the element as well as a package of properties. Returning the properties with the element prevents otherwise subsequent calls (such as those of FIG. 16) that would have had to have been made incident to receiving the element. These properties are preferably defined by the CacheRequest, an example of which was provided in Table 16.

In one embodiment, the API that uses CacheRequest keeps track of the active instance on a per-thread basis. For example, using Activate/Push/Pop on one thread affects the current CacheRequest only on that specific thread. Thus, disparate lists can be used against the same UI. For example, consider two client utilities that seek to reference a common target UI: a magnifier utility and a test utility. Both the magnifier and the test utility may run against the same UI, but each can have different property-request lists, or CacheRequests. To carry the aforementioned metaphor forward, this scenario would be somewhat akin to separate families with separate shopping lists seeking groceries from a common grocery store. In the present invention, each client application can request information related to different aspects of the same UI.

Turning now to Table 18, exemplary pseudocode is provided to illustrate that prefetched properties can be accessed in a preferred embodiment via methods such as GetCachedProperty( )/GetCachedPattern( ) accessors of AutomationElement. CLR property accessors that wrap these methods are also available via the Cached Property on AutomationElement.

TABLE 18
Exemplary pseudocode to begin unpacking retrieved information

string name=(string) el.GetCachedPropertyValue( AutomationElement.NameProperty );
Rect
rect=(Rect)el.GetCachedPropertyValue(AutomationElement.BoundingRectangleProperty);
InvokePattern invoke=(InvokePattern)el.GetCachedPattern(InvokePattern.Pattern);

OR

string name = el.Cached.Name;
Rect rect = el.Cached.Rect;

Rather than the “GetCurrent” methods of Table 15, Table 18 illustrates that a “GetCached” method is employed to retrieve information, which can be stored in memory such as cache memory in a preferred embodiment. Caching results is an optional step, which can be done as an API technique so that client application 1714 does not have to get back one lump of data and digest it itself. Note, however, that results need not literally be “cached,” meaning entered into cache memory per se. The term “cache” often has other implications, such as transparently updating the data or tracking when it is valid.

Accessing cached items requires no cross-boundary hit. Consequently, no performance encumbrances associated with facilitating cross-boundary calls are incurred. The scheme employed in a manner consistent with Table 15 crosses process boundaries each time an attribute is retrieved; for example, one to retrieve the string name and one to retrieve properties of a bounding rectangle. But the method consistent with Table 18 incurs no cross-boundary calls; rather, the work of getting the attribute information is already completed with the returning of the element.

The efficiencies and benefits of the present invention's methodology increase multiplicatively with the number of elements and attributes to be returned. In some instances, the cost of cross-process calls are a major part of obtaining a single property. In such instances, if five attributes are gathered according to an embodiment of the present invention, then only one cross-process call (as opposed to five calls) need be incurred; and the present invention would stem a 5-fold improvement over current methods. If twenty five attributes were sought, then the present invention would offer an approximate 25-fold improvement.

The aforementioned code snippets in Table 16, Table 17, and Table 18 apply to any technique that returns an element, such as an element that has the focus, or is at a specific screen location for example.

In an alternative embodiment, attribute sets can be pushed to a client application rather than pulled, using “events.” That is, incident to the occurrence or happening of some event, an element and corresponding attributes are communicated to a client application. Table 19 includes exemplary pseudocode wherein the present invention includes events that trigger such communications.

TABLE 19
Exemplary pseudocode to indicate which properties and
patterns to prefetch when any events are received::

void Init( )
{

// set up event handler
CacheRequest creq = new CacheRequest( )
creq.Add( AutomationElement.NameProperty );
creq.Add( AutomationElement.BoundingRectangleProperty );
using( creq.Activate( ) )
{

Automation.FocusChanged += new

AutomationFocusChangedHandler(OnFocusChanged);

}

}
void OnFocusChanged( object sender,
AutomationFocusChangedEventArgs el)
{

AutomationElement el = (AutomationElement) sender;
Rect rc = el.Cached.BoundingRectangle;
string name = el.Cached.Name;
...

}

As can be seen, incident to the occurrence of a certain event, preselected element and corresponding attributes are sent to the client application. In the illustrative pseudocode in Table 19, the “OnFocusChanged” function provides an example of an event whereby the prefetch functionality is invoked. Here, whenever the focus changes, information (including a set of properties) regarding a certain rectangle property and name property changes is automatically communicated to a designated component, such as a client application.

An example of a practical application in the technological arts of the present invention, consider a screen-magnifier application. It would be beneficial for a magnifier to receive events when the focus changes so they know what area of the screen to magnify. A key information element is a location reference that indicates an area to be magnified. Absent the present invention, a magnifier would first receive an indication of the event, and then need to initiate a cross-process call to request the location identifier. But in accordance with an embodiment of the present invention, the magnifier can be equipped to prerequest that when a focus-change notification is sent to the magnifier, one or more attributes, including location information, is also sent to the magnifier. In this way, the magnifier need not initiate an expensive cross-process call to retrieve the location information.

The prefetching technology described herein can also specify that relatives, such as children and/or descendants should be prefetched. Thus, information about other elements besides those requested can also be gathered. With reference to Table 20, information on a list (such as the CacheRequest) can be requested, but information can be returned that is related to attributes (such as properties or patterns) that relate to child nodes, siblings, parents, etc.

TABLE 20
Exemplary pseudocode, prefetching relatives:

CacheRequest creq = new CacheRequest( );
creq.Add( AutomationElement.NameProperty );
creq.Add( AutomationElement.BoundingRectangleProperty );
creq.Scope = ScopeFlags.Element | ScopeFlags.Children;
AutomationElement el;
using( creq.Activate( ) )
{

el = AutomationElement.FocusedElement;

}
foreach( AutomationElement child in el.Children )
{

string name = child.Cached.Name;
...

}
Rect rect = el.Cached.BoundingRectangle;

But absent the present invention, a client application would have to make many expensive cross-process requests for information regarding each child (or sibling, parent, etc., as the case may be). For example, consider a list box that is composed of list items among other things. Absent the present invention, if information was to be returned regarding the list box, then only information about the list box itself would be returned. But the present invention allows information to be received that relates not only to the list box, but also to the listbox's children, such as the items in the list. Gathering information about 10 names or 10 items would (notwithstanding the present invention) require 20 cross-process calls (one each to obtain the child elements and one each to obtain the child names). But the present invention enables the same amount of information to be gathered with only one cross-process call. As illustratively shown, ScopeFlags.Descendants may be used to derive information about all descendants.

Table 21 provides illustrative pseudocode that relates to explicitly getting specific properties of elements. As show, the exemplary AutomationElement.GetUpdatedCache( ) method is employed to return a new AutomationElement with the updated cache—the existing AutomationElement is not changed.

TABLE 21
Exemplary pseudocode, explicitly reloading the cache

void SomeFunc( AutomationElement el )
{

// Don't know what properties el has, so issue our own request:
CacheRequest creq = new CacheRequest( );
creq.Add( AutomationElement.Name );
AutomationElement elUpdated = el.GetUpdatedCache( creq );
string name = elUpdated.Cached.Name;
...

}

Because AutomationElement caches are immutable, issues are avoided wherein a cache contains inconsistent data from different points in time. In this way, fresh copies of data can be obtained by a client application. In a preferred embodiment, GetUpdatedCache( ) takes an explicit CacheRequest parameter; it does not use the currently active one. This is to make it clear which request is in force; otherwise there may be confusion between whether the currently active CacheRequest is being used, or the one that was used when the AutomationElement was originally acquired. In alternative embodiments, the cache can be periodically updated automatically without user intervention.

With reference to Table 22, exemplary pseudocode is provided to illustrate how pattern attributes can be retrieved according to an embodiment of the present invention. In some situations, a client application (such as client application 1714) may not necessarily be concerned with making immediate use of a target object's pattern, but rather would be interested in knowing whether the object includes a pattern of interest at all.

As previously mentioned, patterns can indicate what operations are possible for a given target object. A rough metaphor may be that of a person requesting information on multiple U.S. Post Offices. Although a person may not necessarily be interested in using say Express Mail services, she may be interested to know what post offices offer that service. Thus, her request is not to mail a letter, but to determine which post offices can, should she want to, facilitate the special mailing. Here, rather than receiving back pattern information per se, the present invention allows client application 1714 to receive indications as to whether the pattern of interest exists for a given object(s).

TABLE 22
Exemplary pseudocode, Pattern Available properties:

CacheRequest creq = new CacheRequest( );
CacheRequest.Add(
AutomationElement.IsInvokePatternAvailableProperty );
AutomationElement el;
using( creq.Activate( ) )
{

el = AutomationElement.FocusedElement;

}
bool invokeAvailable = (bool) el.GetCachedPropertyValue(
AutomationElement.IsInvokePatternAvailableProperty );
bool invokeAvailable = el.Cached.IsInvokePatternAvailable;

For each pattern, a Boolean property, such as the “IslnvokePatternAvailable” property is added to AutomationElement so that clients can determine whether a pattern is currently supported without having to request the pattern object itself. That is, without experiencing the negative aspects associated with the overhead of marshalling a full-pattern object if it is not required. No additional work is needed by providers to implement this—internally, UIAutomation uses the provider-side GetPatternProvider( ) method. Thus, client application 1714 can receive information regarding which operations are possible without having to make multiple expensive cross-process calls to gather that information.

As a result of “Find” functionality described below, returned AutomationElements—such as those in the Children and Parent collections—contain full references to the remote UI object. But this is not always needed by the client application, and may result in unnecessary overhead. For example a screen reader that merely wants to read out the contents of a dialog could prefetch the names and control types of all the items in a dialog and would not need to get the full AutomationElements for those items. But by employing the exemplary technique illustrated in Table 23, it can specify a CacheRequest.ReferenceType of ReferenceType.None to avoid this overhead.

TABLE 23
Exemplary pseudocode - reference options

CacheRequest creq = new CacheRequest( );
creq.Add( AutomationElement.NameProperty );
creq.Scope = ScopeFlags.Element | ScopeFlags.Children;
creq.ReferenceType = ReferenceType.None;
AutomationElement el;
using( creq.Activate( ) )
{

el = AutomationElement.FocusedElement;

}
foreach( AutomationElement child in el.Children )
{

string name = child.Cached.Name;
...

}
// Attempting to get current value will throw an
InvalidOperationException
exception,
// since that requires the AutomationElement to have a
reference to the remote
UI:
string name = (string) el.GetCurrentValue(
AutomationElement.NameProperty );
// or...
string name = el.Current.Name;

An AutomationElement, according to an embodiment and this aspect of the present invention, preferably has two major components: a reference, which is often a cross-process reference—to one or more UI elements (such as UI elements 1711 of FIG. 17) and the cached collection of attributes that have been prefetched. Thus, if a request is made for information related to an element and its children, then a set of elements would be returned that contain the references to the UI of interest as well as all the cached information. In many cases, client application 1714 does not need the remote references. Table 23 illustrates exemplary programmatic code to indicate data is requested back, to the exclusion of maintaining any references to any remote UI components. Maintaining a reference to a remote UI element is metaphorically akin to maintaining a live telephone link between two entities. The link consumes resource, and may not be necessary. Here, the reference options of Table 23 translate to offering a client application the ability to hang up, vis-à-vis the “creq.ReferenceType=ReferenceType.None” line for example. The relevant data (e.g., the cached information), but not the references (e.g., to the underlying remote UI elements, such as UI elements 1711 of FIG. 17), will be retrieved. References can, for example, take the form of a Remote Procedure Call (RPC) or other remoting technology that exposes by reference a component that persists in another process.

In other embodiments, and with reference to Table 24, a compromise-type of scheme (referred to herein as a lightweight reference) is employed whereby a client is aware that it may not need to work with all of the elements returned, but it may want to continue to work with a certain subset of them. In this case, limited information (such as contact details) are stored such that if the client application does need to reference that element, contact can be reestablished easily.

TABLE 24
Exemplary pseudocode: specify a CacheRequest.ReferenceType
of ReferenceType.Lightweight

CacheRequest creq = new CacheRequest( );
creq.Add( AutomationElement.NameProperty );
creq.Scope = ScopeFlags.Element | ScopeFlags.Children;
creq.ReferenceType = ReferenceType.Lightweight;
AutomationElement el;
using( creq.Activate( ) )
{

el = AutomationElement.FocusedElement;

}
foreach( AutomationElement child in el.Children )
{

string name = child.Name;
...

}
// Attempting to get current value will succeed - internally,
the lightweight
// reference will be resolved to a full reference as needed:
string name = (string) el.GetCurrentValue(
AutomationElement.NameProperty );
// or...
string name = el.Current.Name;

A speech-command or control application, for example, may need to reference a lot of information, but may actually only need to use one AutomationElement. In this case, it can specify a CacheRequest.ReferenceType of ReferenceType.Lightweight. When it has determined that it needs to use a specific AutomationElement, it can simply use that element directly—when required, the lightweight reference will automatically be upgraded to a full reference.

“Find” functionality returns AutomationElements populated with the properties and patterns from the currently active CacheRequest in a preferred embodiment. Table 25 provides exemplary pseudocode that illustrates use of the present invention in connection with “find” functionality. Find and FindAll preferably take a ScopeFlags and a Condition as parameters.

TABLE 25
Exemplary pseudocode: using with Find

// Get names of all invokable objects under focused element:
AutomationElement el = AutomationElement.FocusedElement;
Condition condition = new PropertyCondition

(AutomationElement.IsInvokePatternAvailableProperty, true );

CacheRequest creq = new CacheRequest( );
creq.Add( AutomationElement.NameProperty );
AutomationElementCollection resultSet;
using( creq.Activate( ) )
{

resultSet = el.FindAll( ScopeFlags.Descendants, condition );

}
foreach( AutomationElement item in resultSet )
{

string name = item.Cached.Name;
...

}

Exemplary scenarios described above include those situations where a client application desires to prefetch say an item and all its children or descendants. But in other situations, a client may want to have returned to it all elements that satisfy some criteria. For example, “find all the items in a certain dialog box that are buttons,” or “find all items of a UI that have names associated with them” are illustrative “find” requests. The mechanism employed to facilitate this functionality is depicted above in Table 25.

“Find” functionality is integrated with prefetching technology so that incident to a “find” request, attributes (such as properties) are also returned along with the elements that satisfy the provided search criteria. With reference to Table 25, a starting reference is provided, and then a condition. Here, the illustrative condition depicted is a condition to determine whether an “invoke” pattern is present. And the prefetch request instructs a “NameProperty” to be returned along with the element(s) that satisfy the condition. “FindAll” is then employed to determine all elements that satisfy the condition. With prefetch available per the present invention, the elements themselves are returned as well as a respective set of requested attributes, which here is the “name” property. The ScopeFlags parameter to “Find” indicates which nodes to search; whereas the Scope in the Query indicates what should be returned. It is possible to use different values here, e.g., searching all descendants, and for each one that matches, return it and its children.

Based on the aforementioned description, an illustrative API that helps facilitate the functionality described above is provided in Table 26 below.

TABLE 26
Exemplary pseudocode: API

sealed class AutomationElement
{

object GetCurrentPropertyValue( AutomationProperty
property );
object GetCurrentPattern( AutomationPattern pattern );
object GetCachedPropertyValue( AutomationProperty
property );
object GetCachedPattern( AutomationPattern pattern );
AutomationElement Parent { get; }
AutomationElementCollection Children { get; }
AutomationElementInformation Cached { get; }
AutomationElementInformation Current { get; }
int [ ] GetRuntimeId( );
AutomationElement GetUpdatedCache( CacheRequest creq );
// Find functionality
AutomationElement FindFirst( ScopeFlags scope, Condition
condition );
AutomationElement FindAll( ScopeFlags scope, Condition
condition );
// Usual property definitions...
static readonly AutomationProperty NameProperty;
...
// Pattern Available properties...
static readonly AutomationProperty IsInvokePatternAvailable;

}
struct AutomationElementInformation
{

// Mort-friendly wrappers to access Cached or Current values
string Name { get; }
InvokePattern InvokePattern { get; }
...

}
sealed class CacheRequest
{

CacheRequest( );
void Add( AutomationProperty property );
void Add( AutomationPattern pattern );
ScopeFlags Scope { get; set; }
ReferenceType ReferenceType { get; set; }
void Push( );
void Pop( );
IDisposable Activate( );
CacheRequest Clone( );
static Current { get; }

}
[Flags]
enum ScopeFlags
{

| | |
|---|---|
| Ancestors | = 0x01, |
| Parent | = 0x02, |
| Self | = 0x04, |
| Children | = 0x08, |
| Descendants | = 0x10 |

}
enum ReferenceType
{

None,
Lightweight,
Full

}
// Conditions used by AutomationElement.FindFirst and
AutomationElement.FindAll
are same
// as used by Searcher: AndCondition, OrCondition,
NotCondition and
PropertyCondition.
// PatternPresentCondition becomes redundant with the
introduction of the
// IsPatternAvailable properties.

As can be seen, the present invention and its equivalents are well-adapted to providing an improved method and system for representing multiple hierarchal structures as a single hierarchal structure, presenting custom views of the same, evaluating conditions against the structures to help navigate trees and more, and/or prefetching element attributes so that the attributes can be returned with the elements themselves. Many different arrangements of the various components depicted, as well as components not shown, are possible without departing from the spirit and scope of the present invention. For example, a high-level API may be used to apply the optimization of reusing state between nodes while ignoring the cross-process optimization. Also, a low-level operation-at-a-time API may be employed to reuse state information between operations.

The present invention has been described in relation to particular embodiments, which are intended in all respects to be illustrative rather than restrictive. Alternative embodiments will become apparent to those skilled in the art that do not depart from its scope. Many alternative embodiments exist but are not included because of the nature of this invention. A skilled programmer may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described. Not all steps of the aforementioned flow diagrams are necessary steps.

1. A computer-implemented method for obtaining information related to elements of a user interface, the method comprising:
providing a request to identify one or more elements of interest;
providing a list of attributes that are desired to be returned in connection with the element of interest;
requesting the element of interest; and
contemporaneously returning attribute information according to the list of attributes with the element of interest.

2. The method of claim 1, wherein the request to identify an element of interest includes a request to identify relationship information of the elements of interest.

3. The method of claim 2, wherein the list of attributes comprises at least one selection from the following: properties, patterns, or events.

4. The method of claim 3, wherein contemporaneously returning attribute information includes:
bundling attribute information with relationship information; and
communicating the bundle to a requesting component.

5. One or more computer-readable media have computer-useable instructions embodied thereon for performing the method of claim 1.

6. A computer-implemented method for a client application residing in a first process space of obtaining information related to user-interface (UI) elements of a target component residing in a second process space, the method comprising:
describing one or more target UI elements of the target component to be the subject of a query request;
describing one or more attributes of interest that are associated with the one or more target UI elements;
initiating a single cross-process call from the client application to the target component; and
without any further cross-process, returning to the client application results of the query request contemporaneously with the one or more described attributes.

7. The method of claim 6, wherein describing one or more attributes of interest includes:
providing a programmatic list of attributes of interest; and
pairing the programmatic list with the description of the one or more target UI elements.

8. The method of claim 7, wherein the programmatic list is a cache request.

9. The method of claim 7, wherein initiating the single cross-process call includes initiating a call that passes from the first process space into the second process space.

10. The method of claim 7, wherein the returning step includes automatically returning to the client application results of the query request contemporaneously with the one or more described attributes incident to the occurrence of an event in the absence of a request from the client application.

11. One or more computer-readable media having computer-useable instructions embodied thereon for performing the method of claim 6.

12. An Application Program Interface (API) embodied on one or more computer-readable media for obtaining information related to elements of a user interface, the API comprising code for:
receiving a request from a first application for information related to one or more UI elements, the request including a description of attribute information related to the one or more UI elements;
communicating the request to a receiving component that provides both relationship information and attribute information regarding the one or more UI elements; and
contemporaneously communicating both the relationship information and the attribute information to the first application.

13. The API of claim 12, wherein the request includes criteria to be met by the one or more UI elements.

14. The API of claim 13, wherein communicating the request includes communicating the request across a process boundary separating a requesting application from the user interface.

15. The API of claim 14, wherein the requesting application is an assistive-technology application.

16. The API of claim 15, wherein the attribute information includes one or more of: patterns, properties, or functional capabilities of the one or more UI elements.

17. The API of claim 16, further comprising code for facilitating the creation of a representation of the one or more UI elements, the representation including UI-element relationship information as well as attribute information.

18. One or more computer-readable media having computer-useable instructions embodied thereon for performing a method of providing information about one or more user-interface (UI) elements to a client application, the method comprising:
requesting in a single call structural information and attribute information related to elements of a UI (UI elements); and
satisfying the request by providing attribute information together with structural information incident to receiving the single call.

19. The media of claim 18, further comprising:
incident to receiving the provided attribute and structural information, creating a representation of the UI elements, the representation including UI-element relationship information as well as attribute information.
